(19) United States
(12) Patent Application Publication
(10) Pub. No.: US 2025/0267073 A1
(43) Pub. Date: Aug. 21, 2025

(54) METHOD AND DEVICE FOR HANDLING ABNORMAL NETWORK BEHAVIOR IN A WIRELESS COMMUNICATION SYSTEM

(71) Applicant: Samsung Electronics Co., Ltd., Gyeonggi-do (KR)

(72) Inventors: David GUTIERREZ ESTEVEZ, Middlesex (GB); Tingyu XIN, Middlesex (GB)

(21) Appl. No.: 19/051,803

(22) Filed: Feb. 12, 2025

(30) Foreign Application Priority Data
Feb. 15, 2024 (GB) 2402152.9
Apr. 5, 2024 (GB) 2404898.5
Jan. 15, 2025 (GB) 2500505.9

(51) Int. Cl. H04L 41/147; H04L 41/0654; H04L 41/0681

(52) U.S. Cl. CPC H04L 41/147; H04L 41/0654; H04L 41/0681

(57) ABSTRACT

The disclosure relates to a fifth generation (5G) or sixth generation (6G) communication system for supporting a higher data transmission rate. A method and device are provided in which a network data analytics function (NWDAF) receives, from a consumer network function, at least one of a subscription to assistance information for signaling storm analytics or a request for the assistance information. In response to receiving the at least one of the subscription or the request, the NWDAF collects input data from at least one network function. The NWDAF generates signaling storm output analytics based on the input data. The signaling storm analytics include a signaling storm cause. The NWDAF sends the signaling storm output analytics to the consumer network function.

### CROSS-REFERENCE TO RELATED APPLICATIONS

This application claims priority under 35 U.S.C. § 119 (a) to U.K. Application Nos. 2402152.9, 2404898.5, and 2500505.9 filed in the U.K. Intellectual Property Office on Feb. 15, 2024, Apr. 5, 2024, and Jan. 15, 2025, respectively, the contents of which are incorporated herein by reference.

### BACKGROUND

### 1. Field

The disclosure generally relates to techniques for handling abnormal network behavior, and more particularly, to techniques for network data analytics function (NWDAF)-assisted abnormal network behavior handling in a 3^{rd} Generation Partnership Project (3GPP) 5^{th} Generation (5G) new radio (NR) network.

### 2. Description of Related Art

5G mobile communication technologies define broad frequency bands such that high transmission rates and new services are possible. Such technologies may be implemented not only in “Sub 6 GHz” bands such as 3.5 gigahertz (GHz), but also in “Above 6 GHz” bands referred to as millimeter wave (mmWave) including 28 GHz and 39 GHz. In addition, it has been considered to implement 6G mobile communication technologies (also referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the onset of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (e.g., 2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above problems and/or disadvantages and to provide at least the advantages described below.

An aspect of the disclosure provides techniques for handling abnormal network behavior.

According to an aspect of the disclosure, a method is provided for an NWDAF entity in a wireless communication system. The method includes receiving, from a consumer NF entity, a first message for requesting for signaling storm analytics; obtaining input data from at least one NF entity; and transmitting, to the consumer NF entity, a second message including output data for signaling storm analytics which is generated based on the input data.

According to another aspect of the disclosure, a method is provided for a consumer NF entity in a wireless communication system. The method includes transmitting, to an NWDAF entity, a first message for requesting for assistance information for signaling storm analytics; and receiving, from the NWDAF entity, a second message including output data for signaling storm analytics which is based on input data.

According to another aspect of the disclosure, an NWDAF entity is provided for use in a wireless communication system. The NWDAF entity includes a transceiver; and a controller coupled with the transceiver and configured to receive, from a consumer NF entity, a first message for requesting for signaling storm analytics, obtain input data from at least one NF entity, and transmit, to the consumer NF entity, a second message including output data for signaling storm analytics which is generated based on the input data.

According to another aspect of the disclosure, a consumer NF entity is provided for use in a wireless communication system. The consumer NF entity includes a transceiver; and a controller coupled with the transceiver and configured to transmit, to an NWDAF entity, a first message for requesting for assistance information for signaling storm analytics, and receive, from the NWDAF entity, a second message including output data for signaling storm analytics which is based on input data.

### BRIEF DESCRIPTION OF THE DRAWINGS

The above and other aspects, features, and advantages of the disclosure will be more apparent from the following detailed description when taken in conjunction with the accompanying drawings in which:

FIG. 1 is a reproduction of FIG. 4.2.3-1: Non-Roaming 5G System Architecture of 3GPP TS 23.501;

FIG. 2 is a diagram illustrating context transfer procedures;

FIG. 3 is a diagram illustrating a framework of abnormal network behavior prediction, detection, prevention and mitigation, according to an embodiment;

FIG. 4 is a diagram illustrating a general call flow of abnormal network behavior prediction, detection, prevention and mitigation, according to an embodiment;

FIG. 5A and FIG. 5B are a diagram illustrating a procedure of abnormal network behavior prediction, detection, prevention and mitigation, according to an embodiment;

FIG. 6 is a flowchart illustrating a method performed by a network function, according to an embodiment;

FIG. 7 is a flowchart illustrating a method performed by a NWDAF, according to an embodiment;

FIG. 8 is a block diagram illustrating a network entity, according to an embodiment;

FIG. 9 is a diagram illustrating a UE, according to an embodiment;

FIG. 10 is a diagram illustrating a base station, according to an embodiment; and

FIG. 11 is a diagram illustrating a network entity, according to an embodiment.

### DETAILED DESCRIPTION

Embodiments of the disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the disclosure.

3GPP has defined 5G core network (5GC) to have a decomposed architecture with the introduction of a service-based interface (SBI) using hypertext transfer protocol (HTTP)/2 as a baseline communication protocol, and control plane (CP) and user plane. To support the high speed, low latency and high number of users, the 5GC network should be disaster-resilient to provide continuous coverage and connection, in particular for some high priority or high requirement services (i.e., mission critical services, voice call, data streaming).

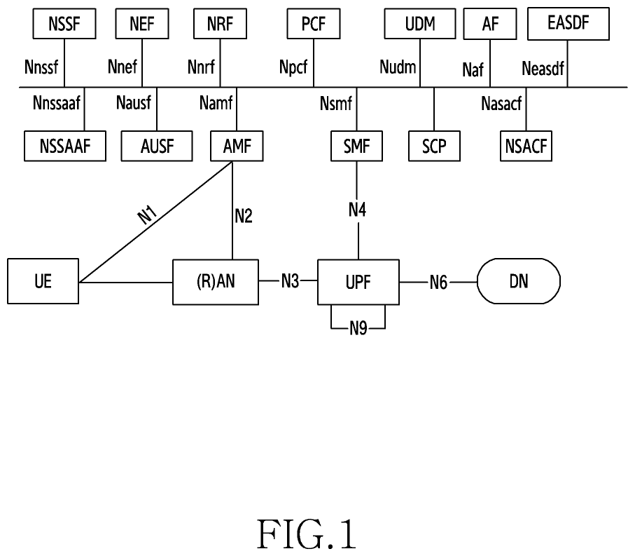

FIG. 1 is a diagram illustrating the 5G system architecture in no-roaming scenario. Network functions (NFs) may interact with each other via different interfaces by invoking corresponding services.

Different NFs host different functionalities to enable the 5G system (5GS) to provide various services to the users. For example, access and mobility management function (AMF) is the termination of random access network (RAN) CP interface (N2) and termination of non-access stratum (NAS) (N1), NAS ciphering and integrity protection support; the AMF provides registration management, connection management, reachability management, mobility management, etc. Based on the functionality that could be provided by the AMF being offline or failure, some of the UEs may not be reachable, new UEs may not access to the network, NAS messages and NG messages may not be sent to the UEs and NG-RAN node, etc. Another example is network repository function (NRF) that supports service discovery, maintains the NF profile of available NF instances and their supported services, maintains the health status of NFs, etc. NFs can interact with NRF to discover the NFs that can provide the service the source NF is looking for or serving the users that the source NF is also serving. The other NFS (i.e., NWDAF) may also interact with the NRF to understand the NF load and the health status of others to maintain the service quality. For the user plane, the user plane function (UPF) links to the RAN node and data network (DN) and transfers the data for users. The UPF is able to perform packet routing and forwarding, packet inspection based on the instruction received from a session management function (SMF), user plane part of policy rule enforcement (e.g., gating, redirection, traffic steering), traffic usage reporting, quality of service (QOS) handling for user plane, downlink packet buffering and downlink data notification triggering, etc.

As every 5GC NFs have their own responsibility to support various 5G services, it is important to ensure the NFs are operating in a healthy condition to avoid any service interruption and degradation and assure the sustainability of the system. For example, the NF or the 5GC may be offline/failed/out due to a cyber-attack (i.e., slicing related security issues: slicing resource depletion attack by maliciously overstretching traffic capacity in a network slice dedicated to a specific service, and subsequently, affect other network slices or simultaneously activate specific applications), unexpected failures of the NF or system (i.e., software errors), during (scheduled) maintenance windows etc. If a service is interrupted or the service quality is degraded due to network issues, the QoS requirements of the service cannot be met. Even for the network maintenance or NF mitigation, a signaling storm may be generated when moving the user, services, configuration, etc., from the affected NFs to other available NFs.

In order to maintain the healthy status and mitigate interruption, 3GPP has introduced some features to detect the system abnormal behaviors from the UE side (i.e., UE abnormal behavior analytics in 3GPP TS 23.288), MDA assisted failure prediction (i.e., clause 8.4.31.1 of 3GPP TS 28.104), security policies and mechanism, control plane load control (i.e., AMF load (re) balancing), NF set principle 3GPP TS 28.104, etc.

With respect to fault isolation, any/other network functions may take over the traffic from the function which is located at the data center where an outage occurred.

For a service interruption, the QoS requirements of the service cannot be met.

For network/NF overloading, there is a network capacity limitation that inappropriate load balancing leads to some NFs being overloaded (i.e., the UE cannot attach due to network capacity).

The network/NF cannot serve new users/services (i.e. UE accessibility issues, UEs cannot access to the network, etc.).

As detailed in clause 5.19 of 3GPP TS 23.501, in order to ensure that the network functions within the 5G system are operating under nominal capacity for providing connectivity and necessary services to the UE, load (re-)balancing of AMF and transport layer network association (TNLA), overload control and NAS level congestion control were introduced. A 5GC NF is considered to be in overload when it is operating over its nominal capacity resulting in diminished performance (including impacts to handling of incoming and outgoing traffic).

The AMF load balancing functionality allows the UEs that are entering an AMF region/AMF set to be directed to an appropriate AMF by considering the load of the available AMFs; and therefore, to balance the load between the AMFs in the same region or AMF set. This may be achieved by setting a weight factor for each AMF. The weight factor can be considered as the probability of selecting an AMF by the RAN node. The probability of selection an AMF is proportional to the weight factor of the AMF. The weight factor is typically set according to the capacity of an AMF node relative to other AMF nodes. The weight factor is sent from the AMF to the 5G-AN via NG application protocol (NGAP) messages (see 3GPP TS 38.413).

The load of the AMF may be varied by the number of the UEs it is serving. The connection status of the UEs will change the load of the AMF (i.e. some of the UEs enter connection management (CM)-IDLE state). However, herein, the weight factor is not changed frequently (e.g., in a mature network, changes on a monthly basis could be anticipated due to the addition of 5G-AN or 5GC nodes). An operator may decide to change the weight factor after the establishment of NGAP connectivity as a result of changes in the AMF capacities (e.g., a newly installed AMF may be given a very much higher weight factor for an initial period of time making it faster to increase its load).

Furthermore, it is required that load balancing by 5G-AN node is only performed between AMFs that belong to the same AMF set (i.e., AMFs with the same PLMN, AMF Region ID and AMF Set ID value), and not all available AMFs.

In some scenarios, the 5G-AN node may have its load balancing parameters adjusted (e.g., the weight factor is set to zero if all subscribers are to be removed from the AMF, which will route new entrants to other AMFs within an AMF set).

The AMF load re-balancing functionality allows a cross-section of its subscribers that are registered on an AMF (within an AMF set) to be moved to another AMF within the same AMF set with minimal impacts on the network and end users. AMF may request some or all of the 5G-AN node(s) to redirect a cross-section of UE(s) returning from CM-IDLE state to be redirected to another AMF within the same AMF set, if the 5G-AN is configured to support this. The AMF may request some or all of the 5G-AN node(s) to redirect the UEs served by one of its globally unique AMF identifier(s) (GUAMI(s)) to a specific target AMF within the same AMF set or to any different AMF within the same AMF set.

When indicating a specific target AMF, the AMF may ensure that the load re-balancing will not cause overload in the target AMF. This requirement can be fulfilled by the AMF itself or by the OAM.

For UE(s) in CM-IDLE state, when a UE subsequently returns from a CM-IDLE state and the 5G-AN receives an initial NAS message with a 5G S-TMSI or GUAMI pointing to an AMF that requested for redirection, the 5G-AN may select the specific target AMF (provided by the original AMF) or a different AMF from the same AMF set and forward the initial NAS message.

For UE(s) in a CONNECTED mode, similar mechanisms for AMF Management may be used to move the UE to another AMF in the same AMF, except that the old AMF deregisters itself from NRF.

The newly selected/target AMF (which is now the serving AMF) will re-assign the globally unique temporary identifier (GUTI) (using its own GUAMI(s)) to the UE(s). It is not expected that the 5G-AN node rejects any request or enables access control restriction when it receives a request for redirection for load control from the connected AMF(s).

When the AMF wants to stop redirection, the AMF can indicate that it can serve all UE(s) in CM-IDLE state to stop the redirection.

Based on the above, the AMF load (re-)balancing is a relatively static mechanism to balance the load between AMFs in the same AMF set. Considering the movements of the users and the massive number of devices that may potentially connect the 5GC, the existing AMF load (re-)balancing cannot provide adaptive and dynamic solutions for AMF load control. Furthermore, this mechanism is only applied for AMF and TNLA with the assistance of RAN node, but is not applicable to other NFs.

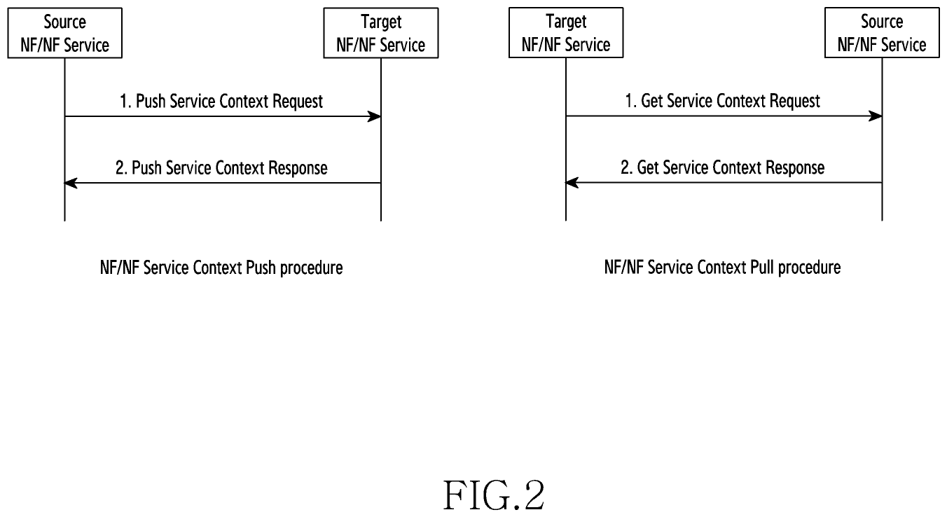

As specified in clause 5.21.3 of 3GPP TS 23.501, an NF instance can be deployed such that several network function instances are present within an NF set to provide distribution, redundancy and scalability together as a set of NF instances. The same is also supported for NF services. This can be achieved when the equivalent NFs and NF services share the same context data or by NF/NF service context transfer procedures as specified in clause 4.26 of 3GPP TS 23.502, as shown in FIG. 2. NF/NF service context transfer procedures allow transfer of service context of a NF/NF service from a source NF/NF service instance to the target NF/NF service instance (e.g., before the source NF/NF service can close its NF/NF service). The source NF/operations, administration, and management (OA&M) system determines when the source NF needs to transfer UE contexts to an NF in another NF set. The source NF may initiate this only for UE(s) that are not active in order to limit and avoid impacting services offered to corresponding UE(s).

Equivalent control plane NFs may be grouped into NF sets (e.g. several SMF instances are grouped into an SMF set, several AMF instances are grouped into an AMF set). NFs within an NF Set are interchangeable because they share the same context data, and may be deployed in different locations by deploying the procedures in FIG. 2, (e.g. different data centers).

In the case of SMF, multiple instances of SMFs within an SMF set need to be connected to the same UPF.

A control plane NF is composed of one or multiple NF Services. Within an NF an NF service may have multiple instances. These multiple NF service instances can be grouped into an NF service set if they are interchangeable with each other because they share the same context data. The actual mapping of instances to a given set is up to deployment.

The NF producer instance is the NF instance which hosts the NF service producer. When the NF producer instance is not available, another NF producer instance within the same NF Set is selected.

When multiple NF service instances within a NF service set are exposed to the NF service consumer or SCP and the failure of the NF service instance is detected or notified by the NRF (i.e., it is not available anymore), the NF service consumer or SCP selects another NF service instance of the same NF service set within the NF instance, if available. Otherwise, the NF service consumer or SCP selects a different NF instance within the same NF Set.

Based on the above description, even though the NF set may provide extra redundancy and reliability of the network, only the switchover between NFs is allowed within the same NF set. The configuration of the NF set is not standardized and up to implementation. The NF can only be replaced by the other NFs within the same NF set minimizing the impacts on the system if the NF/NF service context have been shared. The NF/NF service context share can be triggered by either the source or target NF/NF service. However, for unexpected or unpredicted faults/unscheduled outage/abnormal behaviors, the NFs may be not able to exchange the context sufficiently to enable the network redundancy provided by NF set concept.

Furthermore, NF/NF service context transfer procedures may involve significant signaling if the NF/NF service context is supposed to be exchanged between a large number of NFs.

A new security identifier (SID) on core network enhanced support for AI/ML was approved in SP-231800 in TSG SA Meeting #102 (December 2023).

The terms and words used herein are not limited to their standard meanings, but are merely used to enable a clear and consistent understanding.

Herein, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Herein, the singular form, for example “a”, “an” and “the”, encompasses the plural unless the context otherwise requires. For example, reference to “an object” includes reference to one or more of such objects.

Herein, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

One of ordinary sill in the art will appreciate that the techniques described herein may be used in any suitable combination.

Certain examples of the disclosure provide one or more techniques for handling abnormal network behavior. For example, certain examples of the disclosure provide one or more techniques for NWDAF assisted abnormal network behavior handling (e.g., prediction, detection, prevention and/or mitigation) in a 3GPP 5G NR network. However, one of ordinary skilled in the art will appreciate that the invention is not limited to these examples, and may be applied in any suitable system or standard, such as one or more existing and/or future generation wireless communication systems or standards, including any existing or future releases of the same standards specification (e.g., 3GPP 5G, 5G-advanced or 6G).

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network.

For example, the functionality of a base station or the like (e.g., eNode B (eNB), gNodeB (gNB), NodeB (NB), RAN node, access point, wireless point, transmission/reception point, central unit, distributed unit, radio unit, remote radio head, etc.) described below may be applied to any other suitable type of entity performing RAN functions; the functionality of a UE or the like (e.g., electronic device, user device, mobile station, subscriber station, customer premises equipment, terminal, remote terminal, wireless terminal, vehicle terminal, etc.) described below may be applied to any other suitable type of device; and the functionality of an NWDAF or the like in the examples below may be applied to any other suitable type of entity performing data analytics functions.

A particular network entity may be implemented as a network element on a dedicated hardware, as a software instance running on a dedicated hardware, and/or as a virtualized function instantiated on an appropriate platform, e.g. on a cloud infrastructure.

One of ordinary skill in the art will appreciate that the invention is not limited to the specific examples disclosed herein. The techniques disclosed herein are not limited to 3GPP 5G. One or more entities in the examples disclosed herein may be replaced with one or more alternative entities performing equivalent or corresponding functions, processes or operations. One or more of the messages in the examples disclosed herein may be replaced with one or more alternative messages, signals or other type of information carriers that communicate equivalent or corresponding information. One or more further elements or entities may be added to the examples disclosed herein. One or more non-essential elements or entities may be omitted in certain examples. The functions, processes or operations of a particular entity in one example may be divided between two or more separate entities in an alternative example. The functions, processes or operations of two or more separate entities in one example may be performed by a single entity in an alternative example. Information carried by a particular message in one example may be carried by two or more separate messages in an alternative example. Information carried by two or more separate messages in one example may be carried by a single message in an alternative example. The order in which operations are performed and/or the order in which messages are transmitted may be modified, if possible, in alternative examples.

Certain examples of the disclosure may be provided in the form of an apparatus/device/network entity configured to perform one or more defined network functions and/or a method therefor. Certain examples of the disclosure may be provided in the form of a system (e.g. network or wireless communication system) comprising one or more such apparatuses/devices/network entities, and/or a method therefor.

Certain examples of the disclosure provide a UE/network entity (e.g., AMF, SMF, NWDAF, NF)/base station (e.g., eNB, gNB) configured to perform a method according to any example, aspect, and/or embodiment described herein.

Certain examples of the disclosure provide a network (or wireless communication system) including a UE, a base station (e.g. eNB, gNB), and/or one or more network entities (e.g. AMF, SMF, NWDAF and/or NF) according to any examples, aspects, and/or embodiments described herein.

Certain examples of the disclosure provide a computer program comprising instructions which, when the program is executed by a computer or processor, cause the computer or processor to carry out a method according to any example, aspect, and/or embodiment described herein.

Certain examples of the disclosure provide a computer or processor-readable data carrier having stored thereon a computer program according to any example, aspect, and/or embodiment described herein.

5GS is designed to provide continuous coverage, low latency and high reliability services for massive, connected devices. However, the 5GC NF or the network may behave abnormally (e.g., signaling storm) due to some reasons (i.e., cyber-attack, NF over loaded, NF malfunction etc.). The abnormal network behaviors may result in service degradation and interruption, UE accessibility issues, etc. Therefore, it is necessary to prevent network/5GC NF abnormal behaviors to maintain the service quality that can be provided by 5GC. To prevent the abnormalities, the 5GC may be able to predict the potential abnormal behaviors (i.e., 5GC or NF overloading), and take actions to prevent corresponding abnormal behaviors. Once the abnormal behaviors happens, the 5GC may be able to detect the abnormal behaviors and take actions to mitigate the problems.

However, the framework/mechanism does not support the abnormal network behavior prediction, detection, prevention, and mitigation. It is not clear whether, when, and how to predict which types of network abnormal behaviors and how/what actions are needed to prevent the anomaly. It is also not clear if the anomaly is not prevented, how to detect the abnormal network behavior (in real-time) and the how/what actions are needed to mitigate the anomaly to assure that the network can recover from the disturbance efficiently.

Certain examples of the disclosure provide 5GC functionality of abnormal network behavior prediction, detection, prevention, and mitigation. This 5GC functionality is able to predict, detect, prevent and mitigate abnormal network behaviors based on the assistance information provided by NWDAF analytics.

NWDAF analytics are also enhanced to support abnormal network behavior prediction, detection, prevention and mitigation functionality.

The abnormal network behaviors may include, but are not limited to, a signaling storm. In certain examples, a signaling storm is one possible interpretation of an abnormal network.

The 5GC/5GS signaling storm may be caused by different reasons (e.g., 5GC NF malfunction, massive IoT device registration and data transmission (without good coordination between the service supplier (AF, AS) and the NW operator), network maintenance and upgrade, etc.). For example, if the AMF fails, the UEs that is registered to this AF needs to be transferred to other AFs to maintain the UE services. The UE or network may trigger a (re-) registration procedure. Considering the potential large amount of UEs and the complexity of (re-)registration, massive signaling will be generated in 5GS. A signaling storm might be also caused by abnormal behavior of UEs or distributed denial-of-service (DDoS), NF overloading, impropriate load balancing, traffic scheduling, management and steering, cyber-attack, software errors, etc.

For example, the hijacked UEs or network NFs/entities may keep sending messages and transmitting data to abuse the network. In this case, the hijacked UEs or network NFs/entities may be recognized and isolated/barred by the network (NW).

The NF overloading may result in NF malfunction/misbehaved, and therefore the NF cannot perform the standardized function. For example, when the AMF is overload, new UEs cannot (re-)register/attach to the network. As a result, those UEs cannot be served by the 5GS in a promising manner. In this case, new/other AMFs (instances) may be deployed to take over the load of the overloaded AMF, and the NW may (re-)direct the UEs to (re-)register to those AMFs (instances). An NF malfunction/offline may be due to unexpected reasons (e.g., power supply issue, software or hardware problem, etc.), maintenance, etc. In this case, the existing services may be transferred to other alternative NFs. Massive signaling might be generated to transmit the information, context, etc.

The signaling may include the NAS signaling messages between the UE and the 5GC, signaling within 5GC (i.e., signaling between session management function (SMF), UPF, policy control function (PCF)), signaling between 5GC and RAN, and also the radio resource control (RRC) messages between the RAN and the UE, etc. The massive signaling will increase the 5GS workload significantly and may also interrupt the on-going services and lower the service quality.

Considering the negative impact of abnormal network behaviors (e.g., a signaling storm), it is necessary to minimize the potential risk and 5GS impacts of the abnormal network behaviors. However, there is no definition of signaling storm, and it is unclear how to detect and predict the signaling storm with the assistance of NWDAF, and how to mitigate and prevent the signaling storm.

NWDAF-based analytics may be enhanced to assist with detection or prediction of abnormal network behaviors. As described above, the signaling storm may be caused by different reasons (e.g., DDOS, massive devices connection, 5GS/5GC NF malfunction, etc.). Therefore, in different scenarios, different NFs/service consumers may trigger the request or subscribe to the NWDAF for the analytics that can provide detection and prediction of abnormal network behaviors. Upon receiving the output analytics from the NWDAF, the consumers may take different actions to mitigate or prevent the abnormal network behaviors.

The enhancements to NWDAF-based analytics may include introducing new analytics ID(s), and introducing new inputs, outputs, consumer request information to the existing analytics. The consumers of the analytics may include 5GC NF (e.g. AMF, SMF, NRF, PCF etc.), OAM, and AF.

The abnormal NW behaviors may be reflected by multiple CP and UP factors/events. Based on the real monitoring/measurement, statistics, predictions of the factors/events that can reflect abnormal NW behaviors, the 5GS/5GC/5GC NF consumers are able to determine whether abnormal NW behaviors occur, whether there is a potential risk of the abnormal behaviors occurring; and therefore, corresponding actions may be taken to mitigate or prevent the detected or predicated abnormal NW behaviors. The multiple CP and UP factors/event that can reflect abnormal NW behaviors may include: abnormal/unexpected traffic flow, significant high traffic volume, significant low bit rate and throughput, unusual work load, too frequent/repeating messages/signaling, amount of signaling over threshold/normal load, etc.

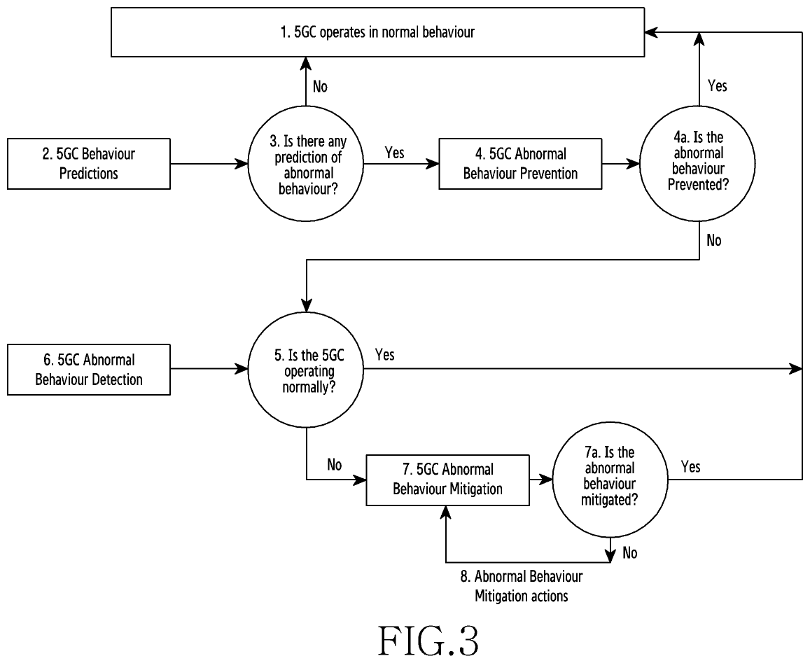

Ideally, the network is expected to work in normal and healthy condition and may have the capability to predict and then prevent the abnormal behaviors, and detect and then mitigate the abnormal behaviors. In certain examples, a framework/mechanism is provided to predict, prevent, detect and mitigate various network abnormal behaviors caused by different reasons to assure the resilience of the network, as shown in FIG. 3.

FIG. 3 is a diagram illustrating a framework of abnormal network behavior prediction, detection, prevention and mitigation, according to an embodiment. In a normal condition, the network is running in a normal and healthy condition, as shown in block 1 of FIG. 3. By deploying the 5GC behavior prediction capability (e.g., by NWDAF), as shown in block 2 of FIG. 3, the network is able to predict/determine whether there is potential (risk of) abnormal network behaviors, as shown in circle 3 of FIG. 3. If there are no potential abnormal network behaviors predicted, the network operates as is, as shown in block 1 of FIG. 3.

If potential abnormal network behaviors are predicted, and if the network is able to take action to prevent the abnormal network behavior, the network will determine to take actions to prevent the corresponding abnormal network behaviors by deploying the 5GC abnormal behavior prevention capability, as shown in block 4 of FIG. 3. If the potential abnormal network behaviors are prevented successfully, based on the assessment made by the NW (4a of FIG. 3), the network continues to work in a normal condition, as shown in block 1 of FIG. 3. The 5GC may determine whether the potential abnormal network behavior is prevented successfully or not by request/subscription to the NWDAF or other 5GC NFs for new/updated abnormal network behaviors prediction. If the prediction does not contain any potential abnormal network behaviors or warnings, the abnormal network behaviors is prevented successfully.

If the potential abnormal network behaviors are not prevented successfully, based on an assessment made by the NW (4a of FIG. 3), the abnormal network behaviors may occur in the system. Whether the abnormal network behaviors occur in the system is based on the decision of abnormal NW behaviors detection capability, as shown in block 6 and circle 5 of FIG. 3. By deploying the 5GC behavior detection capability (e.g., by NWDAF), as shown in block 6 and circle 5 of FIG. 3, the network is able to determine whether there are abnormal network behaviors already occurring in the system: If there are no abnormal network behaviors detected, the network operates as is, as shown in block 1 of FIG. 3.

If abnormal network behaviors are detected, and if the network is able to take actions to mitigate the detected abnormal behaviors, the network will take actions to mitigate the corresponding abnormal behaviors by deploying the 5GC abnormal behavior mitigation capability, as shown in block 7 of FIG. 3. If the abnormal network behaviors are mitigated successfully based on the assessment made by the NW (7a of FIG. 3), the network will be back to a normal and healthy condition, as shown in block 1 of FIG. 3.

The 5GC may determine whether the abnormal network behaviors is mitigated successfully or not by request/subscription to the NWDAF or other 5GC NFs for new/updated abnormal network behaviors detection. If the detection does not contain any abnormal behaviors or warnings, the abnormal network behaviors are mitigated successfully.

If the abnormal network behaviors are not mitigated successfully based on the assessment made by the NW (7a of FIG. 3), the network may keep mitigating the abnormality, as shown in step 8 of FIG. 3. The network may keep mitigating the abnormality until it reaches a limit (e.g., the timer for abnormal behavior mitigation expiries, tries to resolve the problem for curtain times, etc.).

By deploying the above framework, the abnormal NW behaviors may be prevented or mitigated efficiently, thereby ensuring the system is working in a healthy status/level. If the abnormal NW behaviors cannot be predicted and prevented, the abnormal NW behaviors may occur to the system, which will result in service interruption, network offline, no coverage for the UEs etc. If the abnormal NW behaviors cannot be detected and mitigated, the whole 5GC system may collapse and lose its service capability.

In order to maintain the 5GC/5GC NFs in a normal condition sustainably, the prediction of the abnormal network behavior may be implemented before any potential anomaly event happens. The prediction of the abnormal network behavior may provide the potential anomaly/abnormal behavior, the possibility or probability of the corresponding abnormal behavior, the potential time when the anomaly may happen, recommendation of (set of) NFs for UEs/services, recommendation of configuration of NF/network redundancy (i.e., the location of the candidate NFs, NF (set) ID), etc. The prediction and statistics of abnormal network behavior may be provided by NWDAF, any other 5GC NF, or OAM (i.e., MDA) etc.

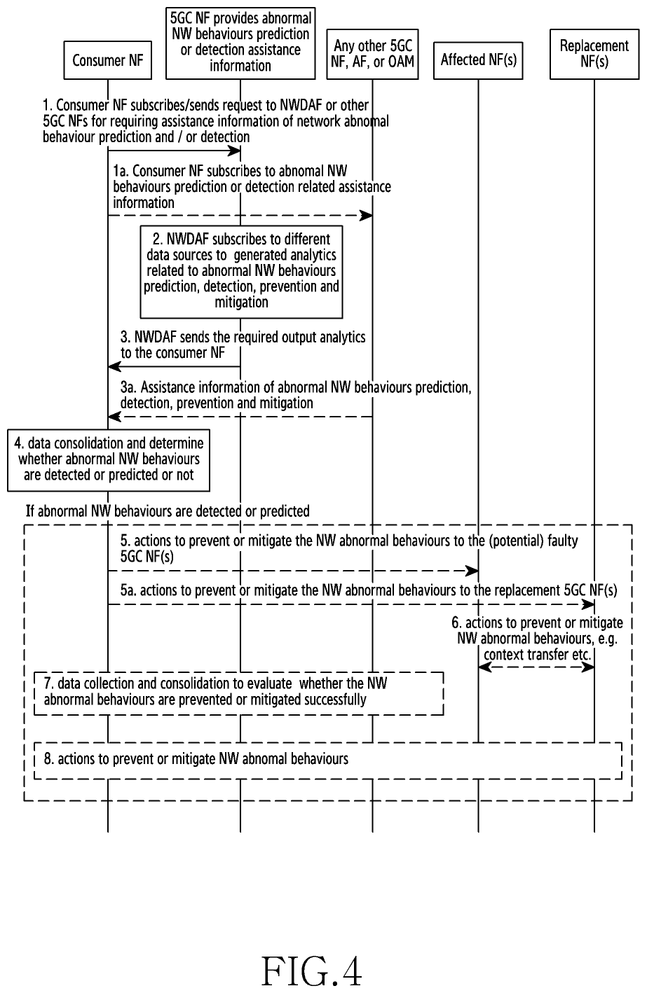

The framework described in FIG. 3 may be represented by the call flow in FIG. 4.

FIG. 4 is a diagram illustrating a general call flow of abnormal network behavior prediction, detection, prevention and mitigation, according to an embodiment.

The 5GC NF that hosts the abnormal network behavior prediction and prevention functionality and abnormal network behavior detection and mitigation functionality (consumer NF) subscribes to or sends a request to NWDAF or other 5GC NFs for assistance information of abnormal network behavior prediction, detection, prevention and mitigation (e.g. by invoking Nnwdaf_AnalyticsSubscription_Subscribe/Nnwdaf_AnalyticsInfo_Request.)

The assistance information may be prediction and/or statistics of the information related to network abnormal behavior; or,

The assistance information may be prediction and/or statistics of abnormal network behavior, the affected 5GC NFs, UEs, RAN node, etc. (e.g. a signaling storm caused by massive IoT device registration to AMF (1, 2, . . . , n) within time window (start time t1—stop time t2)).

1a. The 5GC NF in step 1 may also subscribe or send requests to other 5GC NFs, OAM, AF to require prediction and/or statistics (e.g., from MDAF), historical data, measurements, observed information related to network abnormal behavior.

Upon receiving the request message in step 1, the NWDAF generates the required analytics based on consumer NF request by collecting data from multiple sources and performing AIML model training and inference to generate. The required analytics may be the assistance information that is related to abnormal network behavior prediction, detection, prevention and mitigation.

NWDAF may send the required output analytics to the consumer NF in step 1 (e.g., by invoking Nnwdaf_AnalyticsInfo_Request Response/Nnwdaf_AnalyticsSubscription_Notify).

3a. Any other 5GC NFs, OAM, AF in step 1a may send the required prediction and/or statistics (e.g., from MDAF), historical data, measurements, observed information related to abnormal network behavior to the consumer NF.

The 5GC NF that hosts the abnormal network behavior prediction and prevention functionality and abnormal network behavior detection and mitigation functionality (consumer NF) may consolidate the assistance information related to abnormal network behavior prediction, detection, prevention, and mitigation. Based on the collected information, the 5GC NF may determine whether there are (potential) abnormal behaviors of the network.

If potential abnormal behaviors of the network are predicted, or abnormal behaviors of the network are detected, the 5GC NF (Consumer NF) may interact with affected 5GC NF(s), to prevent or mitigate the corresponding behaviors.

5a. If potential abnormal behaviors of the network are predicted, or abnormal behaviors of the network are detected, the 5GC NF (consumer NF) may interact with replacement 5GC NF(s) that can provide the service/have the capability to replace the affected 5GC NF(s), to prevent or mitigate the corresponding abnormal behaviors of the network.

The affected 5CG NF(s) and the replacement 5GC NF(s) may interact with each other to prevent or mitigate the corresponding abnormal behaviors of the network (e.g., by exchanging NF context, UE context, configuration, buffered data, etc. for a smooth service transition).

The 5GC NF that hosts the abnormal network behavior prediction and prevention functionality and abnormal network behavior detection and mitigation functionality (consumer NF) may repeat step 1-4 to evaluate whether the abnormal NW behaviors are prevented or mitigated successfully. For example, the consumer may request information or data related to abnormal behavior prediction, detection, prevention, and mitigation from NWDAF, and any other 5GC NFs, OAM, AF, RAN node, UE and consolidate the data to determine the whether the abnormal NW behaviors are prevented or mitigated successfully or not.

If the consumer NF determines that the abnormal NW behaviors are NOT successfully prevented or mitigated, the consumer NF may decide to repeat step 5-6 to resolve the (potential) abnormal NW behaviors

Based on the call flow in FIG. 4, one possibility is that the abnormal network behavior prediction may be performed by the NWDAF. The NWDAF generates the prediction of various abnormal network behaviors as output analytics. Then the NWDAF may send the prediction to a network behavior NF to take actions to prevent the abnormal behaviors; or the NWDAF may determine the actions to prevent the abnormal behaviors and directly interact with the affected NFs and/or the replacement NFs.

The 5GC NF that hosts the abnormal network behavior prediction and prevention functionality and abnormal network behavior detection and mitigation functionality (consumer NF) may determine whether there are potential or occurred abnormal NW behaviors based on: its internal logic; and/or configured thresholds (e.g. by the NW operator) based on the SLA etc. The thresholds may be a set of thresholds of different parameters (e.g. the NF load level, the traffic volume, the traffic rate, the numbers of UE failed to register, the numbers of PDU sessions or QoS flow failed to establish, the frequency of a NF providing services/sending message, the frequency of the interactions between 5GC NFs, RAN, UE, AF etc.). If the predicted/observed values of one or more of the parameters are higher/lower than the thresholds, it may determine that there are potential or occurred abnormal NW behaviors in the system/5GC NFs.

The 5GC NF that hosts the abnormal network behavior prediction and prevention functionality and abnormal network behavior detection and mitigation functionality (consumer NF) may determine whether the abnormal NW behaviors are prevented or mitigated successfully or not based on one or more of: its internal logic; and/or configured thresholds (e.g. by the NW operator) based on the SLA, etc. For example, if the measured or predicted load of a NF is back to a certain level, the abnormal behavior is mitigated or prevented; if the service/message frequency of a NF drops to a certain level, the abnormal behavior is mitigated or prevented; if the measured or predicted traffic rate is higher than the threshold, the abnormal behavior is mitigated.

The abnormal network behavior prediction and prevention functionality and abnormal network behavior detection and mitigation functionality may be hosted by a new 5GC NF (e.g., network behavior management NF), or hosted by one or more existing 5GC NF(s) (e.g., PCF, NRF, AMF, NEF, etc.), or the functionality may be implemented by deploying one or more new and/or existing 5GC NF(s). For example, the 5GC NF that hosts the abnormal NW behavior prediction, prevention, detection and mitigation functionalities in charge of the overall abnormal network behaviors, including the abnormal behaviors of other 5GC NF. If abnormal behavior is predicted or detected by this 5GC NF with NWDAF assistance, it determines the actions to be taken to prevent or mitigate the NW abnormal behavior (e.g. by interacting with the other 5GC NFs).

Another possibility is that the 5GC NF has the ability to detect and predict its own abnormal behaviors with NWDAF assistance; and the 5GC NF take corresponding actions to prevent and mitigate its own abnormal behaviors (e.g., by transferring the serving UEs to other replacement NF). For example, the AMF may request or subscribes to assistance information from NWDAF and/or other NFs and AF. Based on the data, the AMF may determine that abnormal behavior of itself is predicted or detected. Then this AMF may take actions to prevent or mitigate the (potential) abnormal behavior (e.g. by re-directing the UEs that registered to it to other AMF).

Based on the prediction, the network/5GC NF/5GS/RAN node/UE or the consumers of the prediction may trigger different actions to prevent the abnormal network behavior from happening.

The prediction may provide the abnormal characteristics of the network (i.e., the throughput of UE or RAN node/traffic rate is significantly low, the load of the UPF is extremely high, the traffic volume from a UE or some of the UEs is increased significantly, network congested, etc.). For example, if a 5GC NF is overloaded, some of the load may be redirected to other equivalent NFs (instances) within the same NF set or out of the same NF set to avoid any potential outage of the overloaded NF.

The network may prevent the abnormal behaviors by taking different actions (i.e., amending the policies related to the service or UEs, steer the traffic to other 5GC NFs, move the NF/NF service/UE context from potential affected NF to other NFs, etc.). For example, based on the prediction, the network may suspend/interrupt/isolate the affected NF/UE/service/slice, and modify the configuration of the NF/UE/service/slice to prevent the abnormal load of the network.

Ideally, the network anomaly may be prevented or the potential risk of abnormal network behavior may be erased based on prediction and prevention mechanism/procedures/actions. However, if the potential anomaly is not prevented efficiently and the network behaves in error, the 5GC should be able to detect the corresponding abnormal behaviors. The detection of the network anomaly might be based on the measurements of monitoring, event exposures, notification/reporting from UE/RAN node/AF/any 5GC NF etc. The detection of the abnormal behaviors may be based on the events/measurements/data which can directly inform the abnormal behaviors, and/or those can inform the abnormal behaviors ‘indirectly’. The network may consolidate multiple service data/measurements/events for the abnormal behavior detection. The outcome of the detection or the network abnormal behavior related events may be notified/exposed to 5GC NF, AF, RAN UE, OAM, etc.

‘Direct’ service data/measurements/events may include: (real-time) data/monitoring/warning related to NF (i.e., NF health status information, NF load, NF responding time, NF failure (per service), UP failure or CP failure of UE or service, etc.).

‘Indirect’ service data/measurements/events may reflect the performance/behavior of UE/5GC/entire system (i.e., service interruption (PDU session suspension/release, UE cannot be reached/offline, network congestion, abnormal/unexpected traffic, degradation of network performance, degradation of service quality/QoS (i.e., UPF failure, user plane congestion etc.), degradation of UE service experience, RAN node related/granularity measurements (i.e., throughput of CU/DU/RAN node/PDCP/RLC, number of active UEs in a cell/slice/served by a RAN node)). Once the abnormal behaviors are detected, in order to recover the performance of the network and service quality, a resilient network may be able to take actions to mitigate the impacts of the anomaly on the network. The network may trigger different procedures based on the abnormal detected behaviors. Some procedures can be implemented for both abnormal behavior prevention and mitigation. i.e.

The network may optimize/modify/provide the NF back-up strategy/NF set configuration for better network redundancy and reliability.

Based on the prediction of the abnormal behaviors, the network operator/5GC NF may generate an optimized back-up strategy configuration to provide better redundancy of the 5GC NF that may potentially behave mistakenly.

Alternatively, based on the detection of the abnormal behaviors, the network operator/5GC NF may modify the back-up strategy configuration to replace the misbehaved NF with other healthy NFs to provide better capability of abnormal network behavior recovery.

The NF/NF service context within the NF set may be timely shared and the UE/service may be re-directed/re-established to the alternative NFs/NF instances to isolate the failed NF (instance)/service/problematic UEs.

Specifically, based on a prediction of the failure time (window) to prepare back-up for the potential anomaly, the NF/NF service context may be shared before the failure happens and may move the affected services/UEs to other alternative NFs.

Based on anomaly detection, to recover the service quality, the network may re-establish the connections for the affected UEs/services to other health 5GC NF/RAN/server.

The network may re-direct/re-establish the connections for the UEs/service by also considering the load and health status of the candidate NFs, the service requirements (i.e., QoS) and traffic related characteristics (i.e., traffic volume, rate, etc.), UE related information (i.e., UE mobility and location), etc.

The network may lower/modify/provide various QoS requirements (i.e., based on negotiation between PCF and AF), update affected policies (i.e., PCC rules) and any other actions, if the network is behaving abnormally to maintain the service continuity, based on the prediction or detection of the abnormal network behaviors.

Specifically, based on prediction of the abnormal behaviors, the 5GC/network (i.e., PCF or AF) may provide/recommend multiple QoS requirements and policies for different times, to prevent network congestion, NF overloading, unexpected/unaccepted service quality degradation due to network anomaly.

Based on the detection of the abnormal behaviors, the 5GC/network (i.e., PCF or AF), may take actions (i.e., lower/modify the QoS requirements and policies (i.e. PCC rules, mobility restriction), traffic scheduling/planning, to reduce the load and requirements of the system, and therefore to help with mitigating the abnormal behaviors).

NF selection may be optimized based on statistics and prediction of abnormal network behaviors, recommendation of NF (re-)selection, and other information to prevent/lower the rate of failure. The considered information may include the NF failure probability, NF load of both the failure NF and the candidate NFs (different from/enhancements to existing criteria), scheduled NF events (maintenance), NF health/load/status, NF priority (i.e., AMF, SMF UPF, UDM may have higher priority), which is generated based on statistics and prediction of NF performance, and/or service/UE priority, requirements, etc.

The abnormal network load, overload and congestion is considered as one of the abnormal network behaviors or the characteristics that can reflect potential or occurred abnormal behaviors of network or 5GC NFs. For example, the abnormal load of NF or the network may be caused by massive IoT device registration, or cyber-attack. The congestion of the control plane and the user plane may be caused by a signaling storm that resulting from abnormal traffic or messages.

Therefore some analytics may provide statistics and predictions information related to NF load, service experience, UE (abnormal) behaviors, traffic related information of UE and network.

The statistics and predictions NF load may be provided by NF load analytics. The NF load analytics may be used by AMF to assist with selecting the SMF for establishing PDU session.

The service experience of application and network slice may be provided by observed service experience analytics.

UE mobility, traffic characteristics and abnormal behaviors may be provided by UE-related analytics (i.e., UE mobility, UE communication, abnormal behavior analytics).

The prediction of some network anomaly may be provided by MDAS analytics.

The above NWDAF-based analytics may also be used by the PCF for making policy decisions.

However, existing parameters/events (i.e., NF related information) and analytics may not be used by the network for abnormal network behavior prediction, detection, prevention, and mitigation.

Herein, the NF load information may be included in the NF profile of the NF instance and managed by NRF. The NF profile may also include: NF capacity information, NF priority information, health status of the NF, etc. Consumers may invoke the NRF service (e.g., Nnrf_NFManagement_NFStatusSubscribe service operation) to request the NF profile.

In clause 6.5 of 3GPP TS 23.288, the predictions and statics of NF load may be provided by NWDAF. The predictions and statics of NF load analytics may be given in per NF instance ID level, the detailed statistics of the analytics are shown in Table 1 (reproduction of Table 6.5.3-1: NF load statistics in clause 6.5 of 3GPP TS 23.388).

TABLE 1

| Information | Description |
|---|---|
| List of resource status (1 . . . max) | List of observed load information for each NF instance |
| | along with the corresponding NF id/NF Set ID (as |
| | applicable). |
| > NF type | Type of the NF instance. |
| > NF instance ID | Identification of the NF instance. |
| > NF status (NOTE 1) | The availability status of the NF on the Analytics target |
| | period, expressed as a percentage of time per status |
| | value (registered, suspended, undiscoverable). |
| > NF resource usage (NOTE 1) | The average usage of assigned resources (CPU, |
| | memory, disk). |
| > NF load (NOTE 1) | The average load of the NF instance over the Analytics |
| | target period. |
| > NF peak load (NOTE 1) | The maximum load of the NF instance over the Analytics |
| | target period. |
| > NF load (per area of interest) | The average load of the NF instances over the area of |
| (NOTE 1, NOTE 2) | interest. |

(NOTE 1):
Analytics subset that can be used in “list of analytics subsets that are requested” and “Preferred level of accuracy per analytics subset”.
(NOTE 2):
Applicable only to AMF load based on Input data in clause 6.5.2, Table 6.5.2-3 and Table 6.5.2-5.

However, the existing NF load may not be enough to assist with abnormal NW behaviors prediction and detection. For example, for the signaling storm scenario, the NF load may be significantly increased due to the signaling of specific services. The signaling may be between 5GC NFs, UEs, RAN nodes, OAM, AF, etc. (e.g., if the signaling storm is caused by the massive IoT device (re-)registrations, the load of AMF Namf_Communication service will be increased significantly, in particular by the service operations of UEContextTransfer, CreateUEContext, RelocateUEContext, RegistrationStatusUpdate, etc.).

In another example, if the NF (e.g., AMF) is overloaded, it may determine to move some UEs/services to other NFs (e.g., AMFs) and also notify the RAN node (e.g., to lower the weight of this AMF when establishing the services/connections to UE). There may be frequent context transfer between the overloaded NF and other replacement NFs. If the overloading decision is not made appropriately, it may overload other replacement NFs that may result in further load balancing procedures. The current load balancing mechanism may cause a signaling storm between the 5GC NFs, 5GC and RAN, and may also have impacts on the UEs. Therefore, it is important to understand the actions and load of the NFs (both overloaded NF and other replacement NFs) (e.g., by understanding the NF load caused by one or more specific NF services (e.g., context transfer)).

However, the current NF load analytics cannot provide the outputs at finer granularities (e.g. NF service (name) level or NF service operations level).

In order to assist the network to predict and detect different types of abnormal NW behaviors, the NF load analytics may be enhanced to finer granularities (e.g., NF service (name) level or NF service operations level). New inputs and outputs are needed. The NF load analytics at finer granularities may also be provided by a new analytics that focuses on abnormal NW behavior detection and/or prediction, or any other existing analytics.

The new input data of NWDAF to generate NF load analytics at finer granularities is shown in Table 2.

The new output analytics provided by NWDAF of NF load related analytics at finer granularities is shown in Table 3 (statistics and/or predictions of NF load related analytics).

TABLE 2

| Information | Source | Description |
|---|---|---|
| NF load information | NRF | The load of specific NF |
| associated to NF | | instance(s) associated to NF |
| services | | services in their NF profile as |
| | | defined per TS 29.510. |
| NF load information | NRF | The load of a NF instance(s) |
| associated to NF | | associated a specific service |
| operation of a NF | | operation of a NF service in |
| service | | their NF profile. |
| | | This may require enhancements |
| | | to NRF. |
| NF capacity | NRF | The capacity of a specific NF |
| | | instance(s), as defined per |
| | | TS 29.510 |
| NF capacity per NF | NRF | The capacity of a specific NF |
| services | | instance(s) of a specific NF |
| | | service. |
| | | This may require enhancements |
| | | to NRF. |
| NF capacity per NF | NRF | The capacity of a specific NF |
| operation per NF | | instance(s) for a specific service |
| service | | operation of a specific NF |
| | | service. |
| | | This may require enhancements |
| | | to NRF. |

TABLE 3

| Information | Description |
|---|---|
| List of resource status | List of observed load information for each NF instance along with |
| (1 . . . max) | the corresponding NF id/NF Set ID (as applicable). |
| > NF instance ID | Identification of the NF instance. |
| > service ID(s)/service | The identification(s) of NF service(s) or the name(s) of the NF |
| name(s) | service(s) that can identify the NF service associated to NF (peak) |
| | load, NF resource usage etc. of the output analytics in this table. |
| > NF resource usage per | The usage of assigned resources per NF service (CPU, memory, |
| NF service (NOTE 1) | disk) (average or variance value). This parameter could be expressed |
| | as a percentage, e.g. x% of the NF overall resource/NF capacity is |
| | used (by the NF service associated to the service ID/name above). |
| > NF load per NF service | The load of the NF instance of specific NF service(s) over the |
| (NOTE 1) | Analytics target period (average or variance value). |
| > NF peak load per NF | The maximum load of the NF instance of specific NF service(s) over |
| service (NOTE 1) | the Analytics target period. |
| > NF load (per area of | The average load of the NF instances over the area of interest. |
| interest) (NOTE 1, | |
| NOTE 2) | |

(NOTE 1):
Analytics subset that can be used in “list of analytics subsets that are requested” and “Preferred level of accuracy per analytics subset”.
(NOTE 2):
might be applicable to AMF load based on Input data

In a current 3GPP framework, if a UE fails to register/attach to the network, it may re-initiate the connection establishment/(re-)registration (e.g., after the RRC or NAS timers expires). In other use cases, UEs may initiate re-registration or registration update procedures due to mobility or periodic registration. For mobility registration, the UE may trigger it because of, for example, changing to a new tracking area (TA) outside the UE's registration area, updating its capabilities or protocol parameters, etc. If the above procedures fail (e.g., due to NW congestion, NF/NW malfunction, etc.), the UEs may re-initiate the procedures which will result in significant signaling. Therefore, the number of UEs registered to the NW (e.g., which perform registration update or registration) and the number of UEs failed to register to the NW (e.g., which will re-initiate the registration) work jointly with other parameters (e.g., UE trajectory, UE mobility, NW capability, etc.), and are helpful in assisting the NW to predict and detect the signaling storm (abnormal behaviors).

The number of some failed procedures may also reflect that the corresponding 5GC NF(s) are overloaded or misbehaved. For example, if a 5GC NF would like to retrieve data from UDM, but the procedure failed, this may be because that UDM is overloaded by too many requests from consumers, or the UDM is offline.

There are also possibilities that the AMF may need to reroute the registration request to another AMF. The AMF re-allocation procedures is used to reroute the NAS message of the UE to the target AMF during a Registration procedure. Even during the UE registration or connection establishment, the network may send assistance information or control which 5GC NF to choose (e.g. AMF), and the network may not be able to timely update the information of the 5GC NF (e.g., NF load, status information). Therefore, the UEs may still attempt to register to the AMF that will re-allocate UEs to the AMFs. The AMF re-allocation procedure may involve massive system-wide signaling. If a huge amount of UEs attempt to register to the AMF, a signaling storm may occur in the system.

The service consumer may be a 5GC NF (e.g., NEF, the NF that hosts the functionality of abnormal network behavior prediction, detection, prevention and mitigation), AF, OAM, etc.

In the request or subscription, the consumer of these analytics indicates analytics filter information of the analytics that can provide outputs related to abnormal network behavior prediction, detection, prevention and mitigation. The information may include a list of analytics subsets that are requested in Table 5 statistics and/or predictions of (assistance information of) abnormal network behavior/signaling storm detection and prediction and new statistics and predictions of NWDAF in Table 8.

The new input data of NWDAF (to assist other 5GC NFs/AF) to predict or detect the (potential) signaling storm is shown in Table 4.

The new output analytics provided by NWDAF (to assist other 5GC NFs/AF) to predict or detect the (potential) signaling storm is shown in Table 5.

TABLE 4

| Information | Source | Description |
|---|---|---|
| Number of registration | OAM/AMF | Number of registration requests collected |
| requests, including | | from OAM or AMF. |
| the number of initial | | Mean (average)/maximum/variance |
| registration, | | numbers |
| mobility registration | | If the parameters are collected from OAM: |
| update, | | the mean number of registered state |
| periodic registration | | subscribers per AMF, as defined in 5.2.1.1 |
| update, | | of TS 28.552; |
| emergency registration, | | the maximum number of registered state |
| or the overall Number of | | subscribers per AMF, as defined in 5.2.1.2 |
| registration requests of | | of TS 28.552; |
| the above, etc. | | the number of initial registration requests |
| | | received by the AMF, as defined in 5.2.2.1 |
| | | of TS 28.552; |
| | | the number of mobility registration update |
| | | requests received by the AMF, as defined |
| | | in 5.2.2.3 of TS 28.552; |
| | | the number of periodic registration update |
| | | requests received by the AMF, as defined |
| | | in 5.2.2.5 of TS 28.552; |
| | | number of emergency registration |
| | | requests received by the AMF, as defined |
| | | in 5.2.2.7 of TS 28.552;. |
| Number of successful | OAM/AMF | Number of successful registrations collected |
| registrations, including | | from OAM or AMF. |
| the number of initial | | Mean (average)/maximum/variance |
| registration, | | numbers |
| mobility registration | | If the parameters are collected from OAM: |
| update, | | the number of successful initial |
| periodic registration | | registrations at the AMF, as defined in |
| update, | | 5.2.2.2 of TS 28.552; |
| emergency registration, | | the number of successful mobility |
| or the overall Number of | | registration updates at the AMF, as |
| registration requests of the | | defined in 5.2.2.4 of TS 28.552; |
| above, etc. | | the number of successful periodic |
| | | registration updates at the AMF, as |
| | | defined in 5.2.2.6 of TS 28.552; |
| | | number of successful emergency |
| | | registrations at the AMF, as defined in |
| | | 5.2.2.9 of TS 28.552;. |
| | | Mean (average)/maximum/variance of the |
| | | overall registration/registration updates at the |
| | | AMF by summing up all the successful |
| | | registration/registration updates of initial |
| | | registrations, mobility registration, periodic |
| | | registration, emergency registrations etc. |
| Number of failed | OAM/AMF | Number of failed registrations collected from |
| registrations, including | | OAM or AMF. |
| the number of initial | | Mean (average)/maximum/variance |
| registration, | | numbers |
| mobility registration | | the number of failed initial registrations at |
| update, | | the AMF, as defined in 5.2.2.2 of |
| periodic registration | | TS 28.552; |
| update, | | the number of failed mobility registration |
| emergency registration, | | updates at the AMF, as defined in 5.2.2.4 |
| or the overall Number of | | of TS 28.552; |
| registration requests of | | the number of failed periodic registration |
| the above, etc. | | updates at the AMF, as defined in 5.2.2.6 |
| | | of TS 28.552; |
| | | number of failed emergency registrations |
| | | at the AMF, as defined in 5.2.2.9 of |
| | | TS 28.552;. |
| | | Mean (average)/maximum/variance of the |
| | | overall registration/registration updates at the |
| | | AMF by summing up all the failed |
| | | registration/registration updates of initial |
| | | registrations, mobility registration, periodic |
| | | registration, emergency registrations etc. |
| | | To provide this parameter, enhancement to |
| | | AMF events or OAM measurements might be |
| | | needed. |
| | | Another way to calculate the fail registrations |
| | | is: |
| | | failed registrations = total registrations − |
| | | successful registration of overall registration |
| | | or of the initial, the registration updates due to |
| | | mobility, periodic registration, mobility |
| | | registration etc.). |
| Number of subscription data | OAM, UDM | For the UDM abnormal behavior prediction |
| getting requests, including: | | and detection: |
| the overall number | | The (overall) number of subscription data |
| the successful subscription | | getting requests received by the UDM, as |
| data gettings | | defined in clause 5.6.8.1.1 of TS 28.552. |
| the failed subscription data | | the number of successful subscription data |
| gettings | | gettings at UDM, as defined in |
| | | clause 5.6.8.1.2 of TS 28.552. |
| | | The number of failed subscription data |
| | | gettings at UDM, as defined in |
| | | clause 5.6.8.1.3 of TS 28.552. |
| UE ID | AMF | The (list of) UE IDs associated to NAS back- |
| | | off timers. The UE ID could be (5G-)GUTI, |
| | | GPSI, SUPI. |
| UE type/category | AMF | The category/type of UE, e.g. Category M |
| | | UEs, IoT devices, RedCap UE, etc. |

TABLE 5

| Information | Description |
|---|---|
| Number of registration requests, | Predictions and/or statics of the Number of |
| including one or more of: | registration requests collected from OAM or AMF |
| the number of initial registration, | over the Analytics target period. |
| mobility registration update, | Mean (average)/maximum/variance of the |
| periodic registration update, | numbers |
| emergency registration, | |
| or the overall Number of registration | |
| requests of the above, etc. | |
| Number of successful registrations, | Predictions and/or statics of Number of successful |
| including one or more of: | registrations collected from OAM or AMF over the |
| the number of initial registration, | Analytics target period. |
| mobility registration update, | Mean (average)/maximum/variance numbers |
| periodic registration update, | |
| emergency registration, | |
| or the overall Number of registration | |
| requests of the above, etc. | |
| Number of failed registrations, including | Predictions and/or statics of the Number of failed |
| one or more of: | registrations collected from OAM or AMF over the |
| the number of initial registration, | Analytics target period. |
| mobility registration update, | Another way to calculate the fail registrations is: |
| periodic registration update, | failed registrations = total registrations − successful |
| emergency registration, | registration of overall registration or of the initial, |
| or the overall Number of registration | the registration updates due to mobility, periodic |
| requests of the above, etc. | registration, mobility registration etc.). |
| Signaling congestion | The congestion level of signaling, e.g. CP signaling, |
| | NAS signaling. |

(NOTE 1):
Analytics subset that can be used in “list of analytics subsets that are requested” and “Preferred level of accuracy per analytics subset”.

If predication or detection of a large amount of UE (re-)registration or registration update is predicted, to prevent the massive registration/signaling storm, the NW/5GC NF/AMF may optimize the back off timer (e.g., extend the NAS, RRC, or other layers timer; setup different timers for different procedures or UEs to distribute the connection attempts, etc.), and/or deprioritize the 5GC NF that may be involved in/affected by the signaling storm/abnormal behavior, and (re-)direct services to other replacement 5GC NFs/NW nodes. This may prioritize the replacement 5GC NFs/NW nodes to reduce the short-term signaling and avoid signaling storm.

This disclosure aims to leverage NWDAF analytics to support abnormal network behaviors (i.e., signaling storm) mitigation and prevention.

The 5GS signaling storm may be caused by different reasons (e.g., 5GC NF malfunction, massive IoT devices (re-)registration and data transmission within short time, DDOS, etc.). Those 5GS internal and external issues may generate massive system-wide signaling, including the NAS signaling, signaling within 5GC (i.e., signaling between SMF, UPF, PCF, etc.), signaling between 5GC and RAN, and also the RRC signaling, etc. The massive signaling may significantly increase the 5GS workload, create CP congestions, lower service quality, and may result in service interruption. In order to maintain the 5GS operating in a healthy status and minimize the negative impacts of abnormal behaviors (e.g., signaling storm), it may be beneficial to leverage the NWDAF to provide assistance information to support abnormal network behavior prediction, detection, prevention and mitigation functionality within 5GS.

It may be difficult to diagnose a root cause of a signaling storm, but it is possible to predict and detect the abnormal behavior based on the statistics, measurements and predictions of the parameters that can reflect the issue. For example, a large number of UEs attempting to register to the network within a short time in an area (e.g., massive IoT devices, DDOS attack) may generate massive system-wide signaling and may also result in system congestion. The network may reject the attempts of some UEs and configure back-off timers to control the UEs' reattempts. When the timers are expired, those UEs may try to connect to the network. This may bring significant signaling storm to the network. The configuration of the back-off timers is also tricky (e.g. some UEs are battery consumption sensitive, long back-off timers will reduce their lifetime significantly). Therefore, it may be beneficial to leverage the NWDAF to provide the statistics and predictions of the number of registration attempts to the network, and (potential) risk level of signaling storm within the system, the optimized back-off time associated to the UE connection attempts, AMF load of the services related to UE registration procedures, etc.

The required new inputs may include (e.g., by enhancing NF load analytics):
Number of NAS/service operation transactions at an AMF, which may include successful, failed or overall transactions. The transactions may be triggered by the UE (e.g., initial registration, mobility or periodic registration update, service request, etc.);
Number of registration requests at an AMF. The registration request may include the successful, failed or overall registrations. The registrations might be trigger by UE initial registration, mobility or periodic registration update, etc.;
Mobility Management back-off time from AMF; NF resource usage per service operation. For example, the AMF resource usage of UEContextTransfer service operation, RegistrationStatusUpdate service operation, etc.;
NF resource usage per service name and NF resource usage per service operation, E.g. the AMF resource usage of UEContextTransfer service operation, NRF resource usage of Nnrf_NFManagement or Nnrf_NFDiscovery, etc.;
NF capability per service name and per service operation;
NF resource capacity;
In an embodiment, new input information of NWDAF is shown in Table 6 and Table 7.

The output analytics that may assist with abnormal behavior prediction, detection, prevention and mitigation may include the statistics and predictions of (e.g., by enhancing NF load or user data congestion analytics):
Number of NAS/service operation transactions;
Number of registration requests;
Ratio of successful transaction;
Mobility Management back-off time;
Signaling congestion per NF service;
Probability/risk level of abnormal network behavior (e.g., signaling storm (of the NF services));
NF resource usage per NF service operation.

In an embodiment, new output analytics provided by NWDAF are shown in Table 8 and Table 9.

TABLE 6

| Information | Source | Description |
|---|---|---|
| Number of registration requests | OAM/AMF | Number of registration requests at an |
| | | AMF collected from OAM or AMF, e.g. |
| | | the number of successful, failed, and |
| | | overall registration requests. |
| Mobility Management back-off time | AMF | The value of Mobility Management back- |
| | | off time of the UE. |
| NF resource usage per service | NRF | NF resource usage per service name or per |
| | | service operation |
| NF capability per service | NRF | The capacity of NF at per service |
| | | granularity. |

TABLE 7

| Information | Source | Description |
|---|---|---|
| NF ID | OAM/AMF | ID of an AMF in this case |
| Number of NAS transactions | OAM/AMF | Number of NAS transactions (e.g., |
| | | Registration Request, Service Request, |
| | | etc.) at an AMF |
| Number of successful NAS | OAM/AMF | Number of successful NAS transactions |
| transactions | | (e.g., Registration Request, Service |
| | | Request, etc.) at an AMF |
| Number of failed NAS | OAM/AMF | Number of failed NAS transactions (e.g., |
| transactions | | Registration Request, Service Request, |
| | | etc.) at an AMF |
| Number of reattempted NAS | OAM/AMF | Number of reattempted NAS transactions |
| transactions | | (e.g., Registration Request, Service |
| | | Request, etc.) at an AMF |
| Number of registered UEs | OAM/AMF | Number of UEs currently registered at an |
| | | AMF |
| Number of active UEs | OAM/AMF | Number of registered UEs that have active |
| | | NAS message transactions with AMF |
| | | during the observed time duration and |
| | | consuming the resource |
| Number of UEs with successful | OAM/AMF | Number of registered UEs that have |
| NAS transaction | | succeeded NAS message transactions |
| | | with AMF during the observed time |
| | | duration and consuming the resource |
| MM back-off time | AMF | The Mobility Management back-off time |
| | | of UE(s). |
| UE ID | AMF | The (list of ) UE IDs associated to NAS |
| | | back-off timers. The UE ID could be |
| | | (5G-)GUTI, GPSI, SUPI. |
| UE type/category | AMF | The category/type of UE, e.g. Category M |
| | | UEs, IoT devices, UE, etc. |
| Number of NG-RAN | OAM/AMF | Number of NGAP connections with NG- |
| connections | | RAN nodes |
| NF service name(s)/ID(s) | AMF | ID or name of the service operation |
| NF resource usage per service | AMF | Resource usage per service operation |
| | | during the observed time duration |
| NF resource capacity | AMF | Resource capacity of an AMF, e.g. |
| | | assigned virtual resources for the AMF. |

TABLE 8

| Information | Description |
|---|---|
| Number of registration requests | Predictions and/or statics of the Number of |
| | registration requests over the Analytics target |
| | period. |
| | The registration request may include the |
| | successful, failed or overall registrations. The |
| | registrations might be trigger by UE initial |
| | registration, mobility or periodic registration |
| | update, etc. |
| Mobility Management back-off time | Predictions and/or statics of the value of Mobility |
| | Management back-off time of the corresponding |
| | UE(s). |
| Service name(s)/ID(s) | ID or name of the service operation. |
| Service signaling congestion | The percentage of signaling associated to a |
| | service among the overall signaling (e.g. CP, UP |
| | signaling) or congestion. |
| Probability/Risk level of network | Occurrence probability/risk level of network |
| abnormal behavior (NOTE 1) | abnormal behavior of the system or NF, e.g. |
| | signaling storm. |
| | The Risk level might be a percentage value, or |
| | different risk classes (configured by operator), |
| | e.g. low-, medium-, high-risk. |
| NF resource usage per service | NF resource usage per service name or per |
| (NOTE 2) | service operation (average, peak). |
| | Or high-, medium-, low-resource usage level. |
| Signaling storm type/Network | The type of signaling storm/network abnormal |
| abnormal behavior type | behavior, e.g. signaling storm/network |
| | abnormal behavior because of UE registration |
| | (initial registration, mobility registration update, |
| | periodic registration update, emergency |
| | registration, etc.), the registration of different |
| | types of UEs (e.g. category M UE, RedCap UE, |
| | normal UEs), UE re-registration due to |
| | registration failure, NF discovery, NF status |
| | update etc. |
| Time window/slot/point | The time window/slot associated to the output |
| | analytics related network abnormal behaviors. |
| | The time window can be in the past or in the |
| | future, defined by start and/or stop time. The time |
| | window could be an infinite, e.g. starting from |
| | the time point but not stop time, the stop time |
| | might be present or until the abnormal behaviors |
| | is prevented or mitigated. |
| | The time point could be the time point when the |
| | network abnormal behavior is predicted to |
| | happen or when abnormal behavior the detected/ |
| | happened. |

(NOTE 1):
the network abnormal behavior risk level might be configured by the operator or provided by the service consumer via reporting thresholds. For example, the risk level might be classified into the low-/medium-/high- risk level of network abnormal behavior (signaling storm) based on the thresholds. The risk level might be classified by considering the number of the (NAS) signaling/procedures/service operation/request, the number of overall/failed/successful the (NAS) procedures/service operation/request, the load of NF/slice/NG-RAN etc., the per service name/per service operation load of NF/slice/NG-RAN etc.
(NOTE 2):
NF resource usage level per service might be configured by the operator or provided by the service consumer via reporting thresholds. For example, high-, medium-, low-resource usage level classified by the thresholds. The resource usage level might be classified by considering the NF/slice/NG-RAN load per service/per service name against the overall load/capacity of the NF.

TABLE 9

| Information | Description |
|---|---|
| NF ID | ID of an NF, e.g. ID of AMF |
| NF Service Area | Service area of an NF, e.g. service area of an |
| | AMF |
| Number of transactions | Predictions and/or statics of the Number of |
| | signaling transactions over the Analytics target |
| | period. |
| UE ID | AMF |
| MM back-off time | Predictions and/or statics of the length of |
| | Mobility Management back-off time of the |
| | corresponding UE(s). |
| Number of reattempted transactions | Predictions and/or statics of the Number of |
| | reattempted signaling transactions over the |
| | Analytics target period. |
| Ratio of successful transaction | Ratio of successful transaction to the total |
| | attempts |
| Probability/Risk level of abnormal | Occurrence probability/risk level of abnormal |
| network behavior (NOTE 1) | network behavior of the system or NF, e.g. |
| | signaling storm. |
| | The Risk level might be a percentage value, or |
| | different risk classes (configured by operator), |
| | e.g. low-, medium-, high-risk. |
| NF service name(s)/ID(s) | ID or name of the service operation. |
| Service signaling congestion | The percentage of signaling associated to a |
| | service among the overall signaling (e.g. CP, UP |
| | signaling) or congestion. |
| NF resource usage per service | NF resource usage per service operation |
| (NOTE 2) | (average, peak) over the Analytics target period. |
| | Or high-, medium-, low-resource usage level. |
| NF resource capacity remaining | Resource capacity available at an AMF. |
| Abnormal network behavior type | The type of abnormal network behavior type, e.g. |
| | the signaling storm due to massive UE |
| | registration, NF discovery, etc. |
| Time window/point | The time window/point associated to the above |
| | output analytics. |

(NOTE 1):
the abnormal network behavior risk level may be configured by the operator or provided by the service consumer via reporting thresholds (e.g., low-/medium-/high- risk level of abnormal network behavior (signaling storm) classified by the thresholds.
(NOTE 2):
NF resource usage level per service might be configured by the operator or provided by the service consumer via reporting thresholds, e.g. low-/medium-/high- resource usage level classified by the thresholds.

The new inputs and outputs of NWDAF may be supported by enhancing the existing analytics ID and/or introducing new analytics ID.

If the signaling storm is predicted by the prediction, detection, prevention and mitigation functionality based on the assistance information provided by NWDAF, in order to avoid potential degradation of the network performance, the network may determine to take different actions to prevent the signaling storm. For example, for the massive number of UEs that will be register to the network in an area, the network may, based on the load and resource usage of the AMF in the area and the risk level, re-direct the existing UEs to other replacement AMFs, optimize the back off timer, re-configure the weight factor of the AMFs to RAN node, etc.; therefore, reserve more resources for the potential heavy connection to prevent potential signaling storm.

After taking actions, the functionality may assess whether the abnormal behavior is prevented successfully or not based on NWDAF analytics and observed measurements, subject to operator policy and thresholds. If the potential risk of the signaling storm is not removed successfully, the potential risk may develop to actual signaling storm in the network.

It is also possible to leverage NWDAF to assist the 5GC to detect the abnormal network behavior, both predictions and statistics of the information related to abnormal network behaviors may be deployed for the detection. The NWDAF consumers may use the statistics in the past to determine whether the abnormal behavior already occurred in the system, and may use the prediction in the future to evaluate the network performance during the period when abnormal behavior may happen. Once the signaling storm is detected and the cause the signaling storm is identified (e.g., signaling storm caused by frequent NF (de-)registration due to NF status), the network may decide to migrate the UEs or services from this NF to other replacement NFs and isolate the faulty NF. The decision making of abnormal network behavior prediction, detection, prevention and mitigation is based on internal logical of the network function (e.g., by deploying operator's policy or pre-configured thresholds).

By enhancing NWDAF to provide the statistics and predictions of the information that can assist with abnormal network behaviors, the 5GC may be able to perform prediction, detection, prevention and mitigation; and therefore, provides the services to the UEs in a more service quality guaranteed manner.

For example, based on the assistance information provided by NWDAF triggered by threshold reporting, in particular the statistics of the output analytics, the network may be able to determine whether a signaling storm already occurred in the system. Based on the assistance provided by the NWDAF, the network may take actions to mitigate the detected abnormal behaviors. If the network abnormal behaviors are mitigated successfully based on the assessment (e.g., subject to operator policy), the network will be back to normal and healthy operating condition.

In order to allow the abnormal behavior prediction, detection, prevention and mitigation functionality to understand the services the network function is working on, and therefore, to predict and detect if there is any (potential) risk of signaling storm, it may be beneficial to generate the NF load analytics at per service name or per service operation level. The NF load of specific services (e.g., NRF load increased by NF discovery service may result in signaling storm). If the signaling storm is predicted, in order to avoid degradation of the network performance, the network may take different actions to prevent the signaling storm, based on the prediction. For example, for the massive number of UEs that will register to the network in an area, the network may, based on the load and resource usage of the candidate AMFs, re-direct the existing UEs to other replacement AMFs, optimize the weight factor of the AMFs to RAN node, etc. Therefore, it may reserve more resources for the potential heavy connection request over the prediction period.

It may be possible that a massive amount of IoT devices might be scheduled to wake up to send data to the applications. Considering the potential large amount of IoT devices in many scenarios (e.g., in a power plant), the devices will create significant signaling, for example, for registration, data transmission etc., which may overload the NAS. For NAS congestion control, the AMF may reject the requests from some of the UEs and may also notify UEs of a different back off timer to distribute the UEs' reattempts to different times, and therefore, spread out the load of NAS and also the signaling between 5GC NFs.

However, configuring the back off timers for UEs, may delay the data transmission of those UEs. In an ideal condition, after reporting the data to the network, the devices may go back to sleep or a power saving mode. Configuring the back off timers for UEs, in particular the power consumption sensitive UEs, may hold the UEs in a relatively high power consumption mode, which may significantly reduce the lifetime of those UEs.

In order to predict and prevent the signaling storm of the network, it may be beneficial for the network to understand the statistics and predictions of the UEs that will attempt to connect to the network (e.g. the UEs that will register to the network, and the successful registrations and failure registrations). Therefore, the network may have an understanding of the potential signaling that may occur.

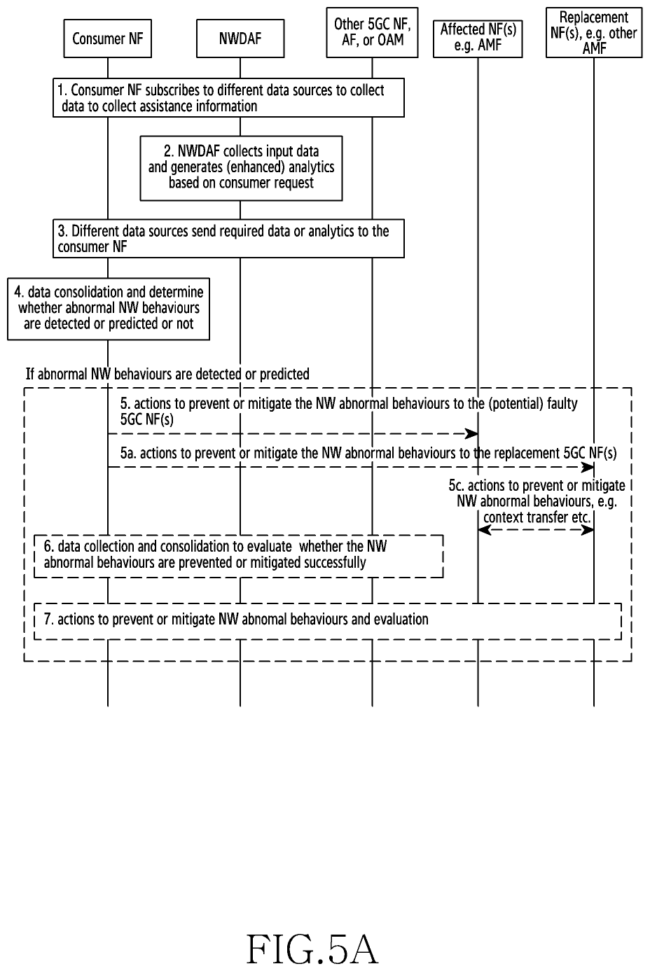

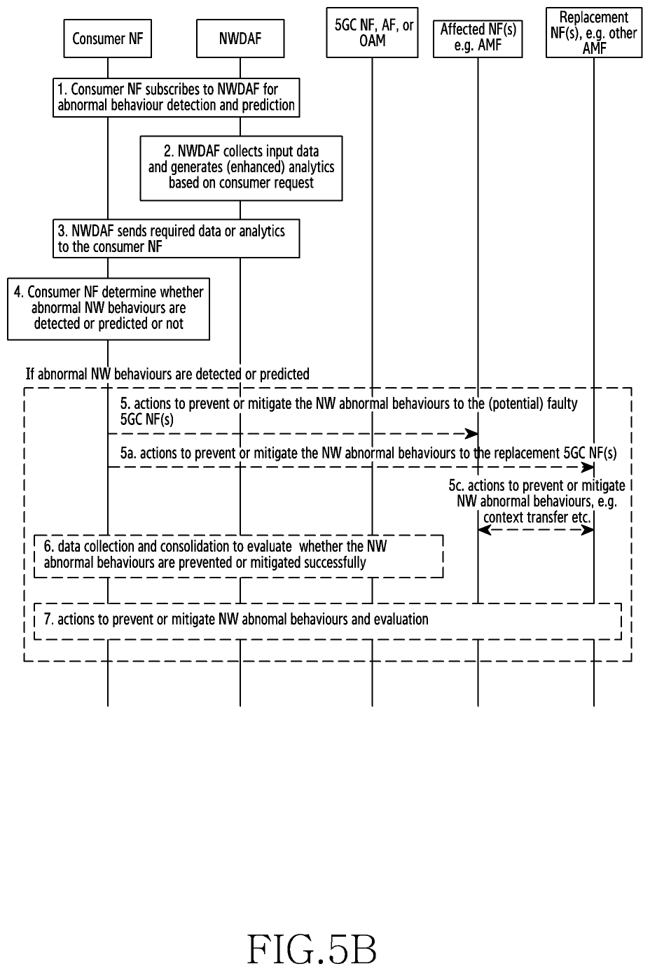

FIG. 5A is a diagram illustrating a procedure of abnormal network behavior prediction, detection, prevention and mitigation, according to an embodiment.

The 5GC consumer NF that hosts the abnormal network behavior prediction, detection, prevention and mitigation functionality (consumer NF) may subscribe to or send a request to collect assistance information of abnormal network behavior prediction, detection, prevention and mitigation. The consumer may interact with multiple data sources for information collection (e.g., NWDAF, 5GC NF (e.g. NRF), OAM, etc.).

The consumer NF may require the NWDAF to provide the prediction and statistics of assistance information, for example, by indicating the required analytics ID(s) and the required outputs in the request, e.g. per NF service NF load provided by NF load analytics ID, service signaling level provided by congestion analytics, etc.

The abnormal network behavior prediction, detection, prevention and mitigation functionality is hosted by a NF that is co-located with an existing NF (e.g., NWDAF, NEF, etc.) or a standalone network function is FFS.

The consumer NF may also subscribe or send request other 5GC NFs, OAM, AF to require the observed or historical data or information that may help with network abnormal behavior prediction, detection, prevention and mitigation.

Upon receiving the request message in step 1, the NWDAF may generate the required analytics based on the consumer NF request. The NWDAF may collect the required input data of the analytics from different data sources, perform AI/ML model training and inference, and generate the required output analytics.

The different data sources in step 1 send the required data or analytics (for NWDAF) to the consumer NF.

In an embodiment, the NWDAF may sends the requested analytics to the consumer NF.

The consumer NF may consolidate all the input data and determine the whether abnormal network behaviors are predicted or detected, e.g. based on the internal logic of the consumer NF.

If potential abnormal behaviors in the network are predicted or abnormal behaviors of the network are detected (e.g. based on the risk level of abnormal network behavior, abnormal network behavior type, NF resource capacity remaining), the 5GC NF (Consumer NF) will interact with affected 5GC NF(s), to prevent or mitigate the corresponding.

The consumer NF may take different actions to prevent or mitigate different abnormal behaviors. The consumer NF will take the information collected in step 4 into consideration for decision making. But the decision is made by the consumer NF based on its own internal logic.

For example, if the consumer NF determines that the predicted or detected signaling storm resulted from an excessive amount of UE registration, the consumer NF may interact with the affected AMF(s) to redirect the attempts from the existing or new UEs to other potential replacement AMFs with sufficient remaining resource for the time window, configure the optimized the back-off time to UEs to optimize the network and UE behaviors; and, therefore, prevent the signaling storm.

The affected NFs and the replacement NFs may also interact with each other for a smooth service transition (e.g., by transferring service, NF or UE context, buffered data, etc.).

The consumer NF may take different actions to prevent or mitigate different abnormal behaviors. The consumer NF will take the information collected in step 4 into consideration for decision making. But the decision is made by the consumer NF based on its own internal logic.

For example, if the consumer NF determines that the predicted or detected signaling storm is resulted by UE registration, the consumer NF may interact with the affected AMF(s) which the UEs register to and other potential replacement AMFs to optimize AMF resources, redirect existing or upcoming UEs etc., to prevent or mitigate the signaling storm.

After taking actions to prevent or mitigate the abnormal network behaviors, the consumer NF that hosts the abnormal network behavior prediction, prevention, detection, and mitigation functionality may repeat steps 1-4 to evaluate whether the abnormal network behaviors are prevented or mitigated successfully.

For example, the consumer may request information or data related to abnormal behavior prediction, detection, prevention and mitigation from NWDAF, and any other 5GC NFs, OAM, AF, etc. and consolidate the data to determine the whether the abnormal network behaviors are prevented or mitigated successfully or not based on its internal logic by considering the thresholds and policy pre-configured by the operator or AF.

If the consumer NF determines that the abnormal network behaviors are not successfully prevented or mitigated, the consumer NF may decide to repeat steps 5-6 to resolve and re-evaluate the (potential) abnormal network behaviors until the abnormal behaviors are successfully prevented or mitigated. A timer may be configured for the evaluation. If the consumer NF is not able to prevent or mitigate the abnormal behaviors before the timer expires, the consumer NF may report the issue to other vendors (e.g., the operators), to resolve the issue.

If the NWDAF is the NF that hosts the functionality of network abnormal behavior prediction, prevention, detection and mitigation/the consumer NF in this call flow is NWDAF, the interactions between the consumer NF and NWDAF could be NWDAF internal logic.

Impacts on the NWDAF may include:
Collect new inputs to generate assistance information for abnormal network behavior prediction, detection, prevention and mitigation;
   Generate new outputs to assist with abnormal network behavior prediction, detection, prevention and mitigation; and
   Expose the new output analytics to consumers.

Impacts on 5GC NF with abnormal network behavior prediction, detection, prevention and mitigation functionality (e.g., new 5GC NF, NWDAF, NEF, etc.) may include:
Subscribes to or request analytics related to abnormal network behavior prediction, detection, prevention and mitigation;
Decision making on abnormal network behavior prediction, detection;
Decision making on the actions to prevent and mitigate the predicted or detected abnormal network behaviors; and
Interact with other NFs to prevent and mitigate the predicted or detected abnormal network behaviors.

Impacts on other 5GC NFs (e.g., AMF) may include:

Take actions to prevent and mitigate the predicted or detected abnormal network behaviors based on the request or indication from the 5GC NF with abnormal network behavior prediction, detection, and prevention and mitigation functionality.

FIG. 5B is a diagram illustrating a procedure of abnormal network behavior prediction, detection, prevention and mitigation, according to an embodiment.

The 5GC consumer NF that hosts the abnormal network behavior prediction, detection, prevention and mitigation functionality (consumer NF) may subscribe to or send a request to collect assistance information of abnormal network behavior prediction, detection, prevention and mitigation. The consumer may interact with multiple data sources for information collection (e.g., NWDAF, 5GC NF (e.g. NRF), OAM, etc.).

The consumer NF may require the NWDAF to provide the prediction and statistics of assistance information, for example, by indicating the required analytics ID(s) and the required outputs in the request, e.g. per NF service NF load provided by NF load analytics ID, service signaling level provided by congestion analytics, etc.

The abnormal network behavior prediction, detection, prevention and mitigation functionality is hosted by a NF that is co-located with an existing NF (e.g., NWDAF, NEF, etc.) or a standalone network function.

The consumer NF may also subscribe or send request other 5GC NFs, OAM, AF to require the observed or historical data or information that may help with network abnormal behavior prediction, detection, prevention and mitigation.

Upon receiving the request message in step 1, the NWDAF may generate the required analytics based on the consumer NF request. The NWDAF may collect the required input data of the analytics from different data sources, perform AI/ML model training and inference, and generate the required output analytics.

The NWDAF may sends the requested analytics to the consumer NF.

The consumer NF may consolidate all the input data and determine the whether abnormal network behaviors are predicted or detected, e.g. based on the internal logic of the consumer NF.

If potential abnormal behaviors in the network are predicted or detected, the Consumer NF will initiate interactions with affected 5GC NF(s) to prevent or mitigate the corresponding anomaly, e.g. based on the risk level of network abnormal behavior, network abnormal behavior type, NF resource capacity remaining.

For example, if the consumer NF determines that the predicted or detected signaling storm is resulted from the excessive amount of UE registration, the consumer NF may interact with the affected AMF(s) to redirect the attempts from the existing or new UEs to other potential replacement AMFs with sufficient remaining resource for the time window, configure the optimized the back-off time to UEs to optimize the network and UE behaviors; and, therefore, prevent the signaling storm.

The affected NFs and the replacement NFs may also interact with each other for a smooth service transition (e.g., by transferring service, NF or UE context, buffered data, etc.).

After taking actions to prevent or mitigate the abnormal network behaviors, the consumer NF that hosts the abnormal network behavior prediction, prevention, detection, and mitigation functionality may repeat steps 1-4 to evaluate whether the abnormal network behaviors are prevented or mitigated successfully.

For example, the consumer may request information or data related to abnormal behavior prediction, detection, prevention and mitigation from NWDAF, and any other 5GC NFs, OAM, AF, etc. and consolidate the data to determine the whether the abnormal network behaviors are prevented or mitigated successfully or not based on its internal logic by considering the thresholds and policy pre-configured by the operator or AF.

If the consumer NF determines that the abnormal network behaviors are not successfully prevented or mitigated, the consumer NF may decide to repeat steps 5-6 to resolve and re-evaluate the (potential) abnormal network behaviors until the abnormal behaviors are successfully prevented or mitigated. A timer may be configured for the evaluation. If the consumer NF is not able to prevent or mitigate the abnormal behaviors before the timer expires, the consumer NF may report the issue to other vendors (e.g., the operators), to resolve the issue.

Impacts on the NWDAF may include:
Collect new inputs to generate assistance information for abnormal network behavior prediction, detection, prevention and mitigation;
Generate new outputs to assist with abnormal network behavior prediction, detection, prevention and mitigation; and
Expose the new output analytics to consumers.

Impacts on 5GC NF with abnormal network behavior prediction, detection, prevention and mitigation functionality (e.g., new 5GC NF, NWDAF, NEF, etc.) may include:
Subscribes to or request analytics related to abnormal network behavior prediction, detection, prevention and mitigation;
Decision making on abnormal network behavior prediction, detection;
Decision making on the actions to prevent and mitigate the predicted or detected abnormal network behaviors; and
Interact with other NFs to prevent and mitigate the predicted or detected abnormal network behaviors.

Impacts on other 5GC NFs (e.g., AMF) may include:

Take actions to prevent and mitigate the predicted or detected abnormal network behaviors based on the request or indication from the 5GC NF with abnormal network behavior prediction, detection, and prevention and mitigation functionality.

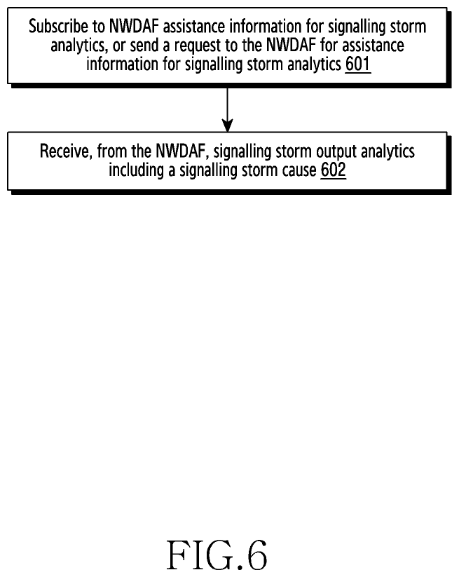

FIG. 6 is a flowchart of an exemplary method performed by a network function (e.g. AMF, SMF, PCF, NRF, OAM, AF), according to an embodiment.

At 601, the network function may subscribe to assistance information for signaling storm analytics, or may send a request to the NWDAF for assistance information for signaling storm analytics.

At 602, signaling storm output analytics may be received at the network function from the NWDAF.

In some examples, the signaling storm analytics may include a signaling storm cause.

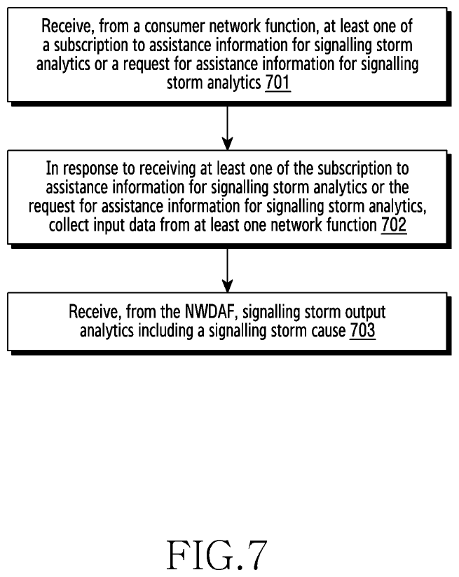

FIG. 7 is a flowchart illustrating an exemplary method performed by a NWDAF, according to an embodiment.

At 701, the NWDAF may receive, from a consumer network function (e.g. AMF, SMF, PCF, NRF, OAM, AF), at least one of a subscription to assistance information for signaling storm analytics or a request for assistance information for signaling storm analytics.

In response to receiving at least one of the subscription to assistance information for signaling storm analytics or the request for assistance information for signaling storm analytics, at 702, the NWDAF may collect input data from at least one network function.

At 703, the NWDAF may generate signaling storm output analytics based on the input data.

In some examples, the signaling storm analytics may include a signaling storm cause.

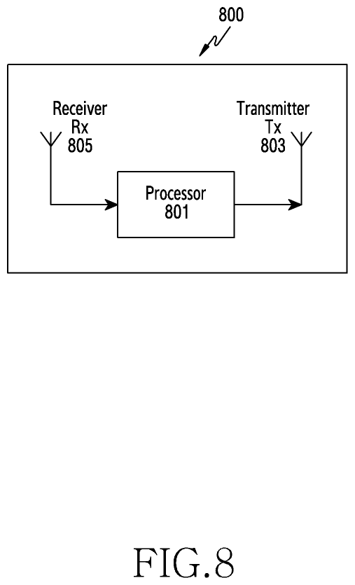

FIG. 8 is a block diagram of a network entity, according to an embodiment. For example, a UE/network entity (e.g., AMF, SMF, NWDAF, AF)/base station (e.g., eNB, gNB) in FIGS. 1-7 may include an entity of FIG. 8. A network entity may be implemented, for example, as a network element on a dedicated hardware, as a software instance running on a dedicated hardware, and/or as a virtualized function instantiated on an appropriate platform, e.g. on a cloud infrastructure.

An entity 800 includes a processor (or controller) 801, a transmitter 803 and a receiver 805. The receiver 805 may be configured for receiving one or more messages from one or more other network entities, for example, as described above. The transmitter 803 may be configured for transmitting one or more messages to one or more other network entities, for example, as described above. The processor 801 may be configured for performing one or more operations, for example, according to the operations as described above.

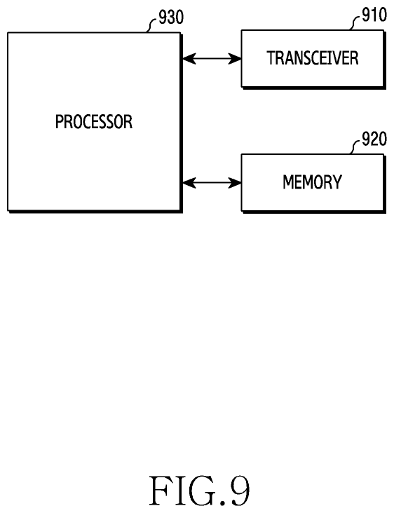

FIG. 9 is a diagram illustrating of a UE, according to an embodiment.

As shown in FIG. 9, the UE may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor.

The transceiver 910 may collectively refer to a UE receiver and a UE transmitter, and may transmit/receive a signal to/from a base station or a network entity. The signal transmitted or received to or from the base station or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE. Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

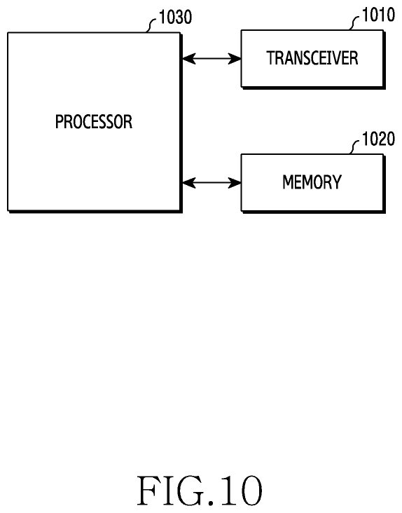

FIG. 10 is a diagram illustrating a base station, according to an embodiment.

As shown in FIG. 10, the base station may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. Also, the processor 1030 may include at least one processor.

The transceiver 1010 may collectively refer to a base station receiver and a base station transmitter, and may transmit/receive a signal to/from a terminal (or UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

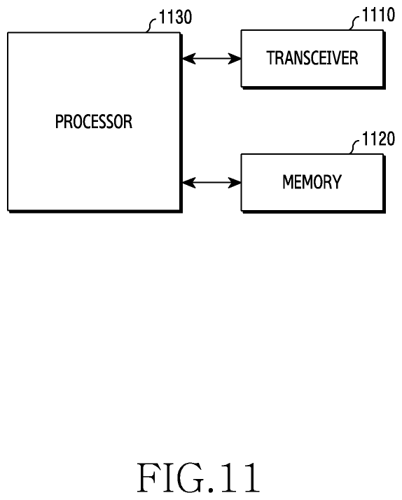

FIG. 11 is a diagram illustrating a network entity, according to an embodiment.

The network entity may include a transceiver 1110, a memory 1120, and a processor 1130. The transceiver 1110, the memory 1120, and the processor 1130 of the network entity may operate according to a communication method of the network entity described above. However, the components of the terminal network entity are not limited thereto. For example, the network entity may include fewer or a greater number of components than those described above. In addition, the processor 1130, the transceiver 1110, and the memory 1120 may be implemented as a single chip. Also, the processor 1130 may include at least one processor.

The network entity includes at least one entity of a core network. For example, the network entity includes an Access and mobility management function (AMF), a session management function (SMF), a policy control function (PCF), a network repository function (NRF), a user plane function (UPF), a network slicing selection function (NSSF), an authentication server function (AUSF), a unified data management (UDM) and a network exposure function (NEF), but the network entity is not limited thereto. For example, the network entity includes a user equipment (UE), a base station (BS).

The transceiver 1110 collectively refers to a network entity receiver and a network entity transmitter, and may transmit/receive a signal to/from a base station or a UE. The signal transmitted or received to or from the base station or the UE may include control information and data. In this regard, the transceiver 1110 may include an RF transmitter for up-converting and amplifying a frequency of a transmitted signal, and an RF receiver for amplifying low-noise and down-converting a frequency of a received signal. However, this is only an example of the transceiver 1110 and components of the transceiver 1110 are not limited to the RF transmitter and the RF receiver.

The transceiver 1110 may receive and output, to the processor 1130, a signal through a wireless channel, and transmit a signal output from the processor 1130 through the wireless channel.

The memory 1120 may store a program and data required for operations of the network entity. Also, the memory 1120 may store control information or data included in a signal obtained by the network entity. The memory 1120 may be a storage medium, such as a ROM, a RAM, a hard disk, a CD-ROM, and a DVD, or a combination of storage media.

The processor 1130 may control a series of processes such that the network entity operates as described above. For example, the transceiver 1110 may receive a data signal including a control signal, and the processor 1130 may determine a result of receiving the data signal.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

In various embodiments disclosed herein, A method performed by a network function, the method comprising: subscribing to a network data analytics function (NWDAF), or sending a request to the NWDAF, for assistance information for signaling storm analytics; and receiving, from the NWDAF, signaling storm output analytics comprising a signaling storm cause.

In an embodiment, the method further comprising: performing at least one prevention or mitigation operation in response to receiving the signaling storm output analytics.

In an embodiment, the at least one prevention or mitigation operation is based on the signaling storm cause.

In an embodiment, the signaling storm cause comprises at least one of: a first cause based on UE signaling; or a second cause based on abnormal network function (NF) signaling.

In an embodiment, performing of the at least one prevention or mitigation operation comprises at least one of: optimizing a back off timer; deprioritizing a network function; modifying a network function configuration; suspending the network function; or directing or redirecting user equipments (UEs) or services to at least one network function.

In an embodiment, the back off timer is optimized for a set of UEs.

In an embodiment, the at least one prevention or mitigation operation is based on an operator policy.

In various embodiments, a method performed by a network data analytics function (NWDAF), the method comprising: receiving, from a consumer network function, at least one of a subscription to assistance information for signaling storm analytics or a request for the assistance information; in response to receiving the at least one of the subscription or the request, collecting input data from at least one network function; and generating signaling storm output analytics based on the input data, wherein the signaling storm analytics comprise a signaling storm cause.

In an embodiment, the method further comprising sending the signaling storm output analytics to the consumer network function.

In an embodiment, the input data comprises at least one of: a user equipment (UE) identifier (ID); a number of requests received by a network function; a number of successful requests at the network function; a number of failed requests at the network function; or non-access stratum (NAS) mobility management back-off timer information.

In an embodiment, the requests comprise at least one of: initial registration requests; mobility registration requests; or periodic registration requests.

In an embodiment, the network function is an access and mobility management function (AMF).

In an embodiment, input data comprises at least one of: network function profile information; network function load information; network function capacity information; or network function priority information.

In an embodiment, the network function load information comprises first information on a current load of a network function and network function services.

In an embodiment, the network function capacity information comprises second information on a capacity of the network function and the network function services, or the network function priority information comprises third information on a priority of the network function and the network function services.

In an embodiment, input data is collected from a network repository function (NRF).

In an embodiment, signaling storm output analytics comprise at least one of: signaling storm statistics, or signaling storm predictions.

In an embodiment, the signaling storm statistics comprise at least one of: network function ID information; signaling storm cause information; information on a number of received requests; service operation names or identifiers; or NAS mobility management back-off timer information.

In an embodiment, the signaling storm predictions comprise at least one of: network function ID information; signaling storm cause information; service operation names or identifiers; information on a number of received requests; NAS mobility management back-off timer information; or network function priority information.

While the disclosure has been particularly shown and described with reference to embodiments thereof, it will be understood by those skilled in the art that various changes in form and details may be made therein without departing from the scope of the subject matter as defined by the appended claims and their equivalents.

What is claimed is:

1. A method performed by a network data analytics function (NWDAF) entity in a wireless communication system, the method comprising:
receiving, from a consumer network function (NF) entity, a first message for requesting for signaling storm analytics;
obtaining input data from at least one NF entity; and
transmitting, to the consumer NF entity, a second message including output data for signaling storm analytics which is generated based on the input data.

2. The method of claim 1, wherein the input data includes at least one of a user equipment (UE) identifier (ID), first information on a number of requests from a UE, second information on a number of requests from an NF entity, or third information on a timer.

3. The method of claim 2, wherein the first information includes a number of successful responses for the requests from the UE and a number of failed responses for the requests from the UE, and
wherein the second information includes a number of successful responses for the requests from the NF entity and a number of failed responses for the requests from the NF entity.

4. The method of claim 1, wherein the input data includes at least one of fourth information on an NF profile, fifth information on NF load status, or sixth information on NF capacity and priority.

5. The method of claim 1, wherein the output data includes at least one of NF identifier, information on a cause of signaling storm, information on a service operation, information on a number of signaling messages within a time window, information on a timer for a UE, or information on a priority, and
wherein the information on the cause indicates one of massive signaling from a UE or NF abnormal signaling.

6. A method performed by a consumer network function (NF) entity in a wireless communication system, the method comprising:
transmitting, to a network data analytics function (NWDAF) entity, a first message for requesting for assistance information for signaling storm analytics; and
receiving, from the NWDAF entity, a second message including output data for signaling storm analytics which is based on input data.

7. The method of claim 6, wherein the input data includes at least one of a user equipment (UE) identifier (ID), first information on a number of requests from a UE, second information on a number of requests from an NF entity, or third information on a timer.

8. The method of claim 7, wherein the first information includes a number of successful responses for the requests from the UE and a number of failed responses for the requests from the UE, and
wherein the second information includes a number of successful responses for the requests from the NF entity and a number of failed responses for the requests from the NF entity.

9. The method of claim 6, wherein the input data includes at least one of fourth information on an NF profile, fifth information on NF load status, or sixth information on NF capacity and priority.

10. The method of claim 6, wherein the output data includes at least one of NF identifier, information on a cause of signaling storm, information on a service operation, information on a number of signaling messages within a time window, information on a timer for a UE, or information on a priority, and
wherein the information on the cause indicates one of massive signaling from a UE or NF abnormal signaling.

11. A network data analytics function (NWDAF) entity in a wireless communication system, the NWDAF entity comprising:
a transceiver; and
a controller coupled with the transceiver and configured to:
receive, from a consumer network function (NF) entity, a first message for requesting for signaling storm analytics,
obtain input data from at least one NF entity, and
transmit, to the consumer NF entity, a second message including output data for signaling storm analytics which is generated based on the input data.

12. The NWDAF entity of claim 11, wherein the input data includes at least one of a user equipment (UE) identifier (ID), first information on a number of requests from a UE, second information on a number of requests from an NF entity, or third information on a timer.

13. The NWDAF entity of claim 11, wherein the first information includes a number of successful responses for the requests from the UE and a number of failed responses for the requests from the UE, and
wherein the second information includes a number of successful responses for the requests from the NF entity and a number of failed responses for the requests from the NF entity.

14. The NWDAF entity of claim 11, wherein the input data includes at least one of fourth information on an NF profile, fifth information on NF load status, or sixth information on NF capacity and priority.

15. The NWDAF entity of claim 11, wherein the output data includes at least one of NF identifier, information on a cause of signaling storm, information on a service operation, information on a number of signaling messages within a time window, information on a timer for a UE, or information on a priority, and
wherein the information on the cause indicates one of massive signaling from a UE or NF abnormal signaling.

16. A consumer network function (NF) entity in a wireless communication system, the consumer NF entity comprising:
a transceiver; and
a controller coupled with the transceiver and configured to:
transmit, to a network data analytics function (NWDAF) entity, a first message for requesting for assistance information for signaling storm analytics, and
receive, from the NWDAF entity, a second message including output data for signaling storm analytics which is based on input data.

17. The consumer NF entity of claim 16, wherein the input data includes at least one of a user equipment (UE) identifier (ID), first information on a number of requests from a UE, second information on a number of requests from an NF entity, or third information on a timer.

18. The consumer NF entity of claim 16, wherein the first information includes a number of successful responses for the requests from the UE and a number of failed responses for the requests from the UE, and
wherein the second information includes a number of successful responses for the requests from the NF entity and a number of failed responses for the requests from the NF entity.

19. The consumer NF entity of claim 16, wherein the input data includes at least one of fourth information on an NF profile, fifth information on NF load status, or sixth information on NF capacity and priority.

20. The consumer NF entity of claim 16, wherein the output data includes at least one of NF identifier, information on a cause of signaling storm, information on a service operation, information on a number of signaling messages within a time window, information on a timer for a UE, or information on a priority, and
wherein the information on the cause indicates one of massive signaling from a UE or NF abnormal signaling.
